(19) United States
(12) Patent Application Publication
(10) Pub. No.: US 2015/0129105 A1
(43) Pub. Date: May 14, 2015

(54) Hybrid Mixed Media Decorative Articles and Methods for Making the Same

(71) Applicant: High Voltage Graphics, Inc., Fort Collins, CO (US)

(72) Inventor: Louis Brown Abrams, Fort Collins, CO (US)

(21) Appl. No.: 14/506,437

(22) Filed: Oct. 3, 2014

Related U.S. Application Data
(62) Division of application No. 13/625,797, filed on Sep. 24, 2012.
(60) Provisional application No. 61/538,035, filed on Sep. 22, 2011.
(60) Provisional application No. 61/567,350, filed on Dec. 6, 2011.
(60) Provisional application No. 61/600,423, filed on Feb. 17, 2012.
(60) Provisional application No. 61/600,459, filed on Feb. 17, 2012.
(60) Provisional application No. 61/615,612, filed on Mar. 26, 2012.
(60) Provisional application No. 61/661,230, filed on Jun. 18, 2012.
(60) Provisional application No. 61/662,220, filed on Jun. 20, 2012.
(60) Provisional application No. 61/691,610, filed on Aug. 21, 2012.

(51) Int. Cl. B44C 1/10; C09J 5/06; B32B 37/12; C09J 5/00

(52) U.S. Cl. CPC B44C 1/105; C09J 5/00; C09J 5/06; B32B 37/1284; B32B 37/1207; B32B 2037/1215
USPC 156/62.2; 156/297; 156/277

(57) ABSTRACT

Various decorative articles and methods of manufacturing same are described in which decorative elements are mixed or combined with one another to form highly attractive, dimensionalized articles.

### CROSS REFERENCE TO RELATED APPLICATIONS

The present application claims the benefits of U.S. Provisional Application Ser. Nos. 61/538,035, filed Sep. 22, 2011, entitled “Decorative Articles Including Metalized Films”, 61/600,423, filed Feb. 17, 2012, entitled “Decorative Articles Including Metalized Films”, 61/567,350, filed Dec. 6, 2011, entitled “Flocked Three Dimensional Dyed Textile”, 61/600,459, filed Feb. 17, 2012, entitled “Fast, Low-Melt Hat Applied Graphics”, 61/615,612, filed Mar. 26, 2012, entitled “Texture-Neutralizing Spacer for Inserts”, 61/661,230, filed Jun. 18, 2012, entitled “Film Enhanced Tackleknit”, 61/662,220, filed Jun. 20, 2012, entitled “Film Enhanced Tackleknit”, 61/691,610, filed Aug. 21, 2012, entitled “Film Enhanced Tackleknit”, each of which is incorporated herein by this reference in its entirety.

### FIELD

The present disclosure is directed generally to decorative articles and specifically to mixed media decorative articles.

### BACKGROUND

People for many years have created decorative articles composed of contrasting materials, special effects, prints, and the like. These decorative articles have included flock, woven or knit textiles, metallized films such as those sold by Plus Corporation under the tradename PRIST™. While these articles have, in many cases, been attractive to viewers, they have generally lacked one or more of perceived dimensionality and viscoelastic properties, which has caused the articles to have low perceived value to viewers. In fact, decorative articles have not kept pace with significant advances in textile design and construction and the explosion of special visual effects and higher graphics art standards and requirements realizable in the digital age, which have collectively resulted in higher expectations associated with indicia of perceived value.

There is therefore a need for a new class of decorative articles meeting the more stringent aesthetics requirements of today's society.

### SUMMARY

These and other needs are addressed by the various embodiments and configurations of the present disclosure. This disclosure relates generally relates to hybrid (or multi- or mixed media) articles and methods of making the same that can create graphic products featuring new dimension and added value with a manufacturing precision (e.g., machine vision for registration, laser cutting, etc.) or productivity (ganged decorative articles and/or elements together on sheets, heat laminating multiple decorative articles and/or elements simultaneously in register with one another, etc.) not generally realized before.

The hybrids include multiple decorative elements, including flock, woven, knit, and metallized materials, arranged in any one of a number of combinations and configurations to provide decorative articles, or graphics products, that can have a high degree of aesthetic appeal and be useful for an endless variety of applications, including as badges, logos, emblems, trade or brand names, appliqués, heat transfers, patches, stickers, and so on. The decorative elements can be configured as a base material or insert to provide contrasting decorative properties (e.g., surface geometries (e.g., textures), light or optical reflectivities (e.g., brightness and/or high or low luster and which is typically a function of yarn optical properties and textile construction), constructions, colors, and/or designs), which can provide not only a visual interplay between the contrasting materials (which, as noted, are decorative elements of a whole or single design or image) but also a greater richness and depth of the design or image (e.g., an appearance of 3-D dimensionality) when compared to a design or image made from a single decorative element lying on a common plane and/or having uniform decorative properties over its areal extent. Stated another way, the use of multiple decorative elements (different types of decorative elements and/or common types of decorative elements having differing decorative properties) can greatly increase the perceived value of a design by creating the depth, contrast, and interplay of the various decorative elements. It can permit or enable a design to be subdivided into logical design or decorative elements, which are emphasized (e.g., emphasis effected by locating decorative element on top or foreground) or subordinated (e.g., subordination effected by locating decorative element on the bottom or background), thereby adding to the article a real or perceived 3-D dimensionality and making logical “design sense” to a viewer.

These features can be illustrated by a number of examples. In one example, a flock base material is combined with one or more sublimation dye printed woven and/or knit textile material(s) configured as insert(s) to the base material. In another example, a flock base material is combined with a metallized material configured as an insert to the base material. In yet another example, a textile or woven base material is combined with one or more flock, woven, knit, and/or metallized material(s) configured as an insert to the base material. In yet a further example, a metallized base material is combined with one or more flock, woven, knit, and/or metallized material(s) configured as insert(s) to the base material. A nearly endless variety of other design combinations is possible using the teachings of this disclosure.

A decorative element need not be a textile at all but can be a decorative material, such as the metallized or non-metallized material, such as an elastomeric or non-elastomeric, cast or extruded polymeric film (e.g., a polyurethane, which may or may not be pigmented to render a desired color and/or texture). The non-textile decorative material can be smooth where an appearance of smoothness is desired. It can have coarse texture (like the embossing on an alligator skin pattern) that cannot be done with a textile. It can create a metallic or holographic or other effect. For example, flock material is typically used to provide not only visual effects but also a soft touch, knit and woven materials for precision graphics plus textile surface patterns and yarn type/characteristics, and a metallized material to provide an intricate molded, finely embossed film-forming which are or can be made to resemble metals. In one application, the decorative element is an elastomeric or non-elastomeric multi-layered film having top and bottom substantially clear or optically transparent adhesive layers sandwiching a pigmented, or colored, polymer layer. In another application, the decorative element is an elastomeric or non-elastomeric, radio frequency moldable, multi-layered construction having an adhesive (lower) layer adhered to a pigmented, or colored, polymer (upper) layer. The decorative element can have a series of holes containing metallic particles or other media (e.g., holograms, lenticular, etc.). Radio frequency molding techniques can be used to impart a desired surface texture and/or design to the upper surface of the decorative element. The decorative element can adhere to a base material or substrate depending on the construction of the decorative article. The decorative element should be heat resistant enough (e.g., have sufficiently high melting and softening points) to be substantially unaffected by the thermal history of the decorative element during decorative article manufacture and application to a substrate.

The division of a design, particularly a graphics design, into discrete decorative elements can provide a way to create additional design dimension and a higher perceived value of the article to a viewer. The design to be dimensionalized can be interpreted, or subdivided, manually or with the aid of a computer, into separate different design or decorative elements with the purpose of reassembling the decorative elements with material types to create a perception of dimensionality. As noted, each design or decorative element can be a separate physical layer of material and/or decoration of that layer (e.g., insert). As noted, each layer can be made of different materials treated (e.g., printed, embossed, etc.) in different ways so as to create the desired internal contrast or interplay of the design or decorative elements.

The various decorative elements can be constructed in a variety of ways. The insert and base materials can be combined in a side-by-side arrangement. The side-by-side arrangement can be effected using a window, aperture or other discontinuity in the base or insert material, void or other discontinuity in the base or insert material, or other discontinuity formed in the base or insert material to receive the insert material and/or reveal the base material to the viewer. The side-by-side arrangement can alternatively or additionally be effected using an adhesive-coated tie material, or common support material, to support simultaneously all of the decorative elements. The tie material can be substantially clear, substantially opaque, color matched or contrasted to an overlying material, or a combination thereof. The various decorative elements are placed, in correct registered position, on the adhesive (which, for example, can be a pressure sensitive or hot melt adhesive). The insert and base material can be combined in a stacked arrangement in which the insert material is positioned on top of the base material. Stated another way, the insert material is positioned in some but not other areas of the underlying base material to reveal the base material adjacent to the insert material.

In any of the above constructions, the insert material can be cut, typically by a laser, in register with the base material. In the stacked arrangement, the insert material can be or a tie material selectively in register to the base material to provide the discontinuity in the insert material enabling a viewer to see the insert and base materials side-by-side. Stated another way, the insert material, but not the base material, is laser cut through. The upper or lower surface of the decorative article can be adhered, by a release adhesive, to a carrier or transfer sheet for ease of application to the substrate. In another technique, the decorative elements are adhered, by a release adhesive, to a carrier sheet and laser cut to the desired size and configuration while on the carrier sheet (the carrier sheet itself is not laser cut). Adhesive is then applied to the free, or proud (or free standing) (or free standing), surfaces of the laser cut decorative elements. The carrier sheet maintains the various laser cut decorative elements in the precise registered position until heat pressed, by the adhesive, to the base material to form the stacked-decorative element-type decorative article.

A continuous tie material, such as a preformed, non-adhesive, cast or extruded polymeric film can be common to and used to support the various decorative elements and bind together not only compatible but also incompatible decorative elements. A suitable adhesive, such as a pressure sensitive adhesive or hot melt adhesive film layer, can be used to adhere the various decorative elements to the tie material. Registration marks can be positioned on the tie material to enable application of each decorative element in correct registered position onto the common tie material. The various decorative elements can be adhered to the tie material and laser cut to desired shapes and sizes. Laser cutting may be done in the same or separate (sequential) steps (in which a first decorative element is adhered to the tie material and laser cut, followed by adhering a second decorative element to the tie material and laser cut, and so on).

The metallized material can be applied to an underlying decorative element, such as flock or a textile material, by radio frequency (“RF”) welding techniques to form the stacked-type decorative article. It can also be applied by RF welding techniques to an underlying tie material to form the side-by-side-type decorative article.

The mechanical properties (e.g., Young's modulus of elasticity, tensile strength, viscoelasticity, and/or yield strength) of each the various decorative elements in a common decorative article can be selected to be compatible with, or match, one another (e.g., the modulus of elasticity, tensile strength, viscoelasticity, and/or yield strength of the base and insert materials are typically within about 25%, more typically within about 15%, more typically within about 10%, and even more typically within about 5% of one another).

Adhesives, such as thermosetting or thermoplastic adhesives, can be suitably positioned on the base and/or insert materials to hold, permanently, the various decorative elements in position. The elastomeric mechanical properties (e.g., Young's modulus of elasticity, tensile strength, viscoelasticity, and/or yield strength) of the adhesive(s) can be selected to produce viscoelastic properties matching or exceeding that of the decorative elements (i.e., the modulus of elasticity of the base and/or insert material is higher than that of the adhesive and/or the tensile and/or yield strength of the base and/or insert material is lower than that of the adhesive). For example, knit textiles generally have much greater elastomeric mechanical and/or viscoelastic properties than woven textiles. Particularly when the knit material is used as the base material, the adhesive used to adhere other decorative elements to the knit material or the hybrid article to the substrate, which itself may have high elastomeric and/or viscoelastic properties, can have elastomeric mechanical and/or viscoelastic properties meeting or exceeding those of the knit material. Heat lamination or transfer can be used to adhere the decorative article to other decorative article components during manufacture.

Care is often required to control adhesive flow or egress during manufacture of the hybrid articles or application of the hybrid articles to a (final) substrate. If adhesives of too low viscosity are used, the adhesive can flow through a decorative element, marring, unacceptably, the appearance to the viewer. If adhesive melting and/or softening points are not properly selected, application of heat during manufacture or substrate application can cause dislocation of the decorative elements and an unacceptable appearance of the hybrid article. Generally, the adhesives used to hold together the various decorative elements of the hybrid article have higher melting and softening points than the underlying adhesive used to adhere the article to a substrate. As noted, the various decorative elements can be pre-colored, dyed, or sublimation dye printed. Heat, pressure, and/or dwell time applied during sublimation dye heat transfer printing can also cause unacceptable adhesive migration through the decorative element(s). To avoid or other discontinuity this result, the adhesive(s), particularly adhesives having a melting and/or softening point lower than the thermal history during sublimation dye heat transfer printing, are applied after the printing step.

A release adhesive-coated transfer film, which is preferably substantially clear to permit proper placement on the substrate, can be used to hold discrete decorative elements or hybrid articles in registered position for application to a substrate, such as a textile. For example, the letters in a word or logo, brand name, or other design, can be maintained in discrete, registered positions for simultaneous application, such as by heat transfer, to a substrate. Registration marks on the transfer film can be used to position properly the various decorative elements and/or articles.

These and other advantages will be apparent from the disclosure of the aspects, embodiments, and configurations contained herein.

As used herein, the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

“Adhesive” generally refers to a composition comprising homopolymers, copolymers or polymer alloy comprising one or more of polyolefins, polystyrenes, polyvinyls, polyacrylics, polyhalo-olefins, polydienes, polyoxides, polyesthers, polyacetals, polysulfides, polythioesters, polyamides, polythioamides, polyurethanes, polythiourethanes, polyureas, polythioureas, polyimides, polythioimides, polyanhydrides, polythianhydrides, polycarbonates, polythiocarbonates, polyimines, polysiloxanes, polysilanes, polyphosphazenes, polyketones, polythioketones, polysulfones, polysulfoxides, polysulfonates, polysulfoamides, polyphylenes, and combinations and/or mixtures thereof. More specifically in a preferred embodiment, the thermoplastic adhesive composition comprises one of acrylonitrile butadiene styrene, acrylic (PMMA), celluloid, cellulose acetate, cyclo-olefin copolymer, ethylene-vinyl acetate (EVA), ethylene vinyl alcohol (EVOH), fluoroplastic (PTFE, FEP, PFA, CTFE, ECTFE, and/or ETFE), ionomer, liquid crystal polymer (LCP), polyacetal (POM and/or acetal), polyacrylate (acrylic), polyacrylonitrile (PAN or acrylonitrile), polyamide (PA or nylon), polyamide-imide (PAI), polyaryletherketone (PAEK and/or ketone), polybutadiene (PBD), polybutylene (PB), polybutylene terphthalate (PBT), polycaprolactone (PCL), polychlorotrifluoroethylene (PCTFE), polyethylene terephthalate (PET), polycycloheylene dimethylene terephthalate (PCT), polycarbonate (PC), polyhydroxylalkanoate (PHA), polyketone (PK), polyester, polyethylene(PE), polyetherketoneketone (PEKK), polyetherimide (PEI), polyethersulfone (PES), polysulfone, polyethlenechloriate (PEC), polyimide, polyacetic acid (PLA), polymethylpentene (PMP), polyphenylene oxide (PPO), polyphylene sulfide (PPS), polyphthalamide (PPA), polypropylen (PP), polystyrene (PS), polsulfone (PSU), polytrimethylen terphthalate (PTT), polyurethane (PU), polyvinyl acetate (PVA), polyvinyl chloride (PVC), polyvinylidene chloride (PVDC), styrene-acrylonitrile (SAN), and combinations thereof. The adhesive may be one of a thermosetting adhesive, a thermoplastic adhesive, a substantially A-staged thermosetting adhesive, a substantially B-staged thermosetting adhesive, a self-supporting adhesive film, a bi-laminate adhesive film having first and second adhesive layers, the first adhesive layer and second adhesive layer differing in one or both of chemical composition and physical properties, a tri-laminate adhesive film having a polymeric film positioned between a first adhesive film and a second adhesive film, a fast flow, low-melt adhesive, a hot-melt adhesive; and a combination and/or mixture thereof. Further regarding the tri-laminate adhesive film, the first adhesive film and second adhesive film may differ in one or both of chemical composition and physical properties, or have substantially the same chemical composition and physical properties, and the polymeric film may comprise one or more of an elastomeric material, a substantially inelastic material, clear, opaque, colored, uncolored, or a combination thereof. The polymeric film may be a tie layer.

“Carrier sheet” or “transfer sheet” generally refers to any material that is dimensionally stable under the conditions of temperature and pressure encountered during any of the processing conditions presented herein. Typically, but not always, the carrier sheet is a discontinuous as opposed to a continuous sheet on a running web line. The carrier sheet may be any low-cost, dimensionally stable article to be decorated, such as paper, plastic film, and the like, typically in the form of a discontinuous sheet or a running web line material.

“Cutting” generally refers to any suitable technique and/or method, to form one or more of the article and any of the decorative elements described herein. The article and any of the one or more of the decorative elements can be cut before, during, and/or after registering. The cutting process may be any suitable cutting device known to a person of ordinary skill within the art, such as a steel-rule dies, hard tool metal dies, laser cutter, ultrasound cutter, high frequency cutter, hot-wire cutter, or water jet cutter. Commonly, the cutting process is one of laser or die cutting process. The cutting process may also include an ablation process to improve adhesion of the article and any the one or more decorative elements described herein in subsequent processing. Particularly preferred laser cutting and/or ablation processes are disclosed in U.S. application Ser. No. 11/874,146 to Abrams, which is incorporated in its entirety herein by this reference. Laser cutting is preferred in applications where discoloration is not an issue. While laser cutting can seal and/or fuse the edges, extending the useful area of the article and any of the decorative elements described herein to include the sealed and/or fused edges, it can also cause discoloration (e.g., yellowing) of the article and one or more of the decorative elements in the article due to the condensation of the vaporized material from the cutting/fusing of the laser. In other words, the laser cutting articles and/or decorative elements comprising textile materials can fuse the yarns comprising the cut-edges of textile materials, the fused-edge yarns do not “pop-up” or fray, as do die-cut yarn edges. Laser power and speed of the cutting process commonly affect the degree that cut-edge yarns are fused. For example, low laser power and/or fast cutting speed decrease the degree to which the cut-edge is fused. Optimal fused-edges typically require a balancing of the laser power and line speed to properly fuse most, if not all, of the edge yarns and minimize, or eliminate, “pop-up” or frayed edge yarns. The fused-edges of a decorative article can allow higher processing line speeds. Die-cut edges typically have long loose yarns, such as “float” yarns on the surface, which “pop up” and are easily and quickly frayed. While not wanting to be bound by any theory, one or more fused-edge yarns and the adhesive melt during the laser cutting to form the fused edge. Typically, the appearance of the cut fused-edge has a “beaded-like” appearance. It can be appreciated that, for some applications and designs frayed edges are preferred, such as, designs that have a worn, more casual, and/or more vogue appearance. The fused-edge yarns stay-in place, are more durable and more highly valued by consumers. While it is true that die-cut edges typically have long loose yarns, such as “float” yarns on the surface, which “pop up” and are easily and quickly frayed, it has been surprisingly discovered that die-cutting the product of the present disclosure does not produce this result. The die-cut edge yarns stay-in place, are more durable and more highly valued by consumers. It can be appreciated that, for some applications and designs frayed edges are preferred, such as, designs that have a worn, more casual, and/or more vogue appearance. The die cut-edges also allow higher processing line speeds. While not wishing to be bound by any theory, it appears that edge fibers are fused to some extent by being heated during the applying of one or both of heat and pressure. Commonly, the cutting is performed by a cutting machine having an optical element to identify a selected reference point, such as when registering. The reference point may be identified optically, for example, using reflected laser light in a conventional laser light registration system, as known by those of skill in the art. Optical registration is preferred over using a guide side of the cut out insert (or a prior cut line) because some materials lack sufficient dimensionality to use an edge for registration. Once the desired reference point is identified, the cutting element cuts out the design image using programmed logic to impart accurate registration and to precisely cut out one or more of the article and any one or more of the decorative elements described herein. In this manner, the decorative article and one or more of the decorative elements in the article are cut to the desired size and shape.

“Elastomeric polymeric materials,” “elastomeric polymers,” and “elastomeric materials” generally refer to one or more of rubbers, polyisoprenes, polybutadinenes, styrene-butadienes, chloroprenes, ethylene propylene rubbers, ethylene-vinyl acetates, ethylene propylene diene rubbers, polyacrylic rubbers, epichlorohydrin rubbers, fluorosilicones, fluoroelasters, silicones, perfluoroelastomers, polyether block amides, chlorosulfonated polyethylenes and combinations thereof). Non-limiting examples of stretchable and elastic-knits/stretchable and elastic-weaves are sprang waves, mesh-weaves, open weaves, warp knits, and two-way knits. While not wanting to be limited by example, suitable stretchable and elastic-knits/stretchable and elastic-weave textile materials are Lycra™, Spandex™, 4-, 3-, 2-, or 1-way stretch fleece fabrics, and stretch cotton weaves (such as, stretch rayon jersey knit and/or cotton/Lycra™ combinations).

“Knit” generally refers to a fabric having a series of connected loops. The loops are generally made by intertwining yarn, thread, or strips in a series of consecutive loops, called stitches. As each row progresses, a new loop is pulled through an existing loop. The loops are generally easily stretched in different directions. Knitting normally uses one set of yarn, which is worked either horizontally or vertically, not both. Knitting typically has two recognized knitting structures, namely warp and weft knitting. Warp knitting has one set of yarn for each wale, each yarn travelling vertically. Weft knitting has one set of yarn, which travels horizontally across the fabric. The knitted textile can be formed by any knitting process, including but not limited to weft knitting (in which the wales are substantially perpendicular to the course of the yarn), warp knitting (in which the wales and courses are roughly parallel to each other), knit stitch, purl stitch, stockinette, reverse stockinette, garter stitch, seed stitch, right-plaited stitches, left-plaited stitches, flat knitting, circular knitting, a single yarn knit, a plurality of yarns knit, a double knit textile, an uneven knit, a shadow knit, a fair-isle knit, a plaited knit, flat knitting, circular knitting, or felt knitting. Examples of possible knit patterns or constructions include knits and purls, reversible stitch patterns, eyelets and lace, mosaic stitch patterns, multi-color stitch patterns, and the like. Specific examples of patterns include basketweave, basketweave II, box stitch, broken rib, cable stitch, casting on, casting off, checks and ridges, chevron, close checks, decrease, diagonal rib, diagonals, diamond pattern, double basket weave, double seed stitch, elongated chevron, embossed diamonds, embossed moss rib, garter rib, garter stitch, garter stitch steps, increase, Inverness diamonds, King Charles brocade, knit stitch, large diamonds, little pyramids, mistake rib, mock cable, moss diamonds, moss panels, moss stitch, moss stitch border diamonds, moss stitch parallelograms, parallelograms, parallelograms II, pavilion, pique triangles, plain diamonds, purl stitch, purled ladder, rib stitch, rice stitch, seed stitch, single chevron, slip stitch, spaced checks, squares, squares in squares, stocking stitch, thermal underwear stitch, triangles, triangle ribs, triangle squares, triangles, twin rib, two by two rib, windmill, woven stitch, yarn over, and combinations thereof. A preferred decorative element has knit and purl stitches arranged substantially symmetrically (such as in ribbing, garter stitch, or seed stitch) so that the decorative element lies substantially flat.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

A “metallized material” generally refers to one or more of a polymeric composition-containing metallized particles, a polymeric composition having a metallized coating, a polymeric composition having a metallized appearance, a metal-containing composition, and a combination and/or mixture thereof. The metallized material may comprise a molded polyurethane or silicone. Typically, the metallized material comprises molded polyurethane formed by high-frequency molding and/or shaping processes. More typically, the metallized material comprises molded metal-containing polyurethane formed by high-frequency molding and/or shaping processes. The high frequency molding process is commonly a radio frequency molding process. The molded polyurethane may have a single metallic hue. The metal may be any metal. Generally, the metal is silver, nickel, aluminum, or alloys and combinations thereof. The metal may be encapsulated and/or dispersed in the polymeric material. The metal may be coated to provide for additional and/or different hues. For example, the metal can be coated with yellow hue to provide for a gold look, or dark orange for copper look. Commonly, the metal may be encapsulated and/or dispersed in the polyurethane. While not wanting to be limited by example, the metal may be encapsulated and/or dispersed between two polymeric film layers. The metallized material may or may not include an adhesive layer. The metallized material typically has a metallic surface or metallic-like appearing surface and an opposing surface. The opposing surface may or may not include the adhesive layer. The adhesive layer can be in the form of an adhesive film layer. The metallic-appearing surface is commonly in the form of three-dimensional surface. The three-dimensional surface is formed during the high frequency molding process. Furthermore, edges of the metallized material can formed during the molding process. That is, the edges may be formed using a combination of high frequency energy and/or heat. Furthermore, the edges may be formed during the molding process by the mold die, specifically by the edge of the mold die and the pressure applied during the molding process. The molding process may or may not include welding a textile base to metallized material. Commonly, the metallized material is provided without a textile base. However, when provided with a textile base, the textile base is part of the metallized material. That is, the textile base of the metallized material is not a decorative element as used herein, other than that of the metallized material the textile base is molded thereto. The high frequency molding cannot cut through flock fibers, such as nylon flock fibers, nor through typical textile materials such as polyester-containing textile materials. More specifically, the high frequency molding process cannot cut through polymeric materials having a melting point greater than nylon and/or polyester. Even more specifically, the textile base has a melt temperature no more than about 190 degrees Celsius, commonly no more than about 180 degrees Celsius, even more commonly no more than about 170 degrees Celsius. The metallized material can be one or more of pliable, soft and washable. More specifically, the metallized material can be laundered with clothing. The metallized material can be fabricated to resemble a metallic badge, such as, a police officer's badge, a fire department badge, a federal agent's badge or such.

“Polymer” or “polymer composition” generally refers to a molecule comprising a plurality of repeating chemical groups, typically referred to as monomers. Polymers include man-made polymers, natural polymers and mixtures thereof. Polymers are often characterized by high molecular masses. Useful polymers include organic polymers and inorganic polymers both of which may be in amorphous, semi amorphous, crystalline, partially crystalline states, or combinations thereof. Polymers may comprise monomers having the same chemical composition or may comprise a plurality of monomers having different chemical compositions, such as a copolymer. Cross-linked polymers have linked monomer chains. Useful polymers include but are not limited to plastics, elastomers, thermoplastic elastomers, elastoplastics, thermosets, thermoplastics and acrylates. Exemplary polymers include but are not limited to acetal polymers, biodegradable polymers, cellulosic polymers, epoxies, fluoropolymers, polyolefins, polystyrenes, polyvinyls, polyacrylics, polyhalo-olefins, polydienes, polyoxides/esthers/acetals, polysulfides, polyesters/thioesters, polyamides/thioamides, polyurethanes/thiourethanes, polyureas/thioureas, polyimides/thioimides, polyanhydrides/thianhydrides, polycarbonates/thiocarbonates, polyimines, polysiloxanes/silanes, polyphosphazenes, polyketones/thioketones, polysulfones/sulfoxides/sulfonates/sulfoamides, polyphylenes, nylons, polyacrylonitrile polymers, polyamide, imide polymers, polyimides, polyarylates, polybenzimidazole, polybutylene, polycarbonate, polyesters, polyetherimide, polyethylene, polyethylene copolymers and modified polyethylenes, polyketones, poly(methyl methacrylate), polymethylpentene, polyphenylene oxides and polyphenylene sulfides, polyphthalamide, polypropylene, polyvinyls, polyurethanes, natural and synthetic rubber, silicones, styrenic resins, sulfone based resins, vinyl based resins and any combinations of these.

“Release adhesive” generally refers to any adhesive that adheres more strongly to the carrier or transfer sheet than the appliqué but adheres to both enough to hold them together. For example, the release adhesive may be any temporary adhesive, such as a resin or a copolymer, e.g., a polyvinyl acetate, polyvinyl alcohol, polyvinyl chloride, polyvinyl butyral, acrylic resin, polyurethane, polyester, polyamides, cellulose derivatives, rubber derivatives, starch, casein, dextrin, gum arabic, carboxymethyl cellulose, rosin, silicone, or compositions containing two or more of these ingredients. Commonly, the release adhesive is a water-based adhesive; that is, the release adhesive is one or more of dispersed, dissolved, suspended or emulsified within water.

A “satin” weave and/or satin textile material generally refers to a flat, smoothly woven type weave, such as, but not limited to satin type weaves with an interlacing float of at least 2 or to at least the following satin weave types commonly known within the art as:

a) Brocade—A brocade weave is a compound weave where a supplementary warp or filling yarn is inlaid into a base fabric to produce an embroidered appearance. (The supplementary or filling yarn is a yarn that can be removed without affecting the base fabric.) Brocade weaves can be continuous where the supplementary yarn floats on the back of the base fabric and is not visible on the fabric face, or discontinuous where the supplementary yarn is woven into the patterned areas visible on the fabric face.

b) Brocatelle—A brocatelle weave is a highly textured or high-relief motif produced with an additional yarn the runs between the fabric face and back to produce a pronounced texture, or dimensionality, or relief to the fabric surface. Brocatelle weaves are typically based on, but not limited to, satin weaves.

c) Camocas—A comocas fabric is typically a stain weave with a diapered design.

d) Crepe-back satin, Satin-back crepe, Crepe-satin, or Satin-crepe—These fabrics typically comprise a stain weave on the fabric face and a crepe crinkled affect produced by the weave, yarn or finishing technique on the back of the fabric. Typically weft crepe yarns are twisted and outnumber any supplemental or filling yarn by a factor of at least 2:1.

e) Duchesse—A duchesse weave is a high thread count satin weave, typically woven with fine yarns having a higher density of warp to weft yarns. Duchesse fabrics have a high luster and are highly textured and firm.

f) Satin—A warped-faced satin weave satin weave is a weave where warp yarns pass over multiple weft yarns before interlacing another waft yarn, or filling-faced satin weave where weft yarns pass over multiple warp yarns before interlacing another warp yarn. A satin weave produces a fabric surface where the warp and weft intersection points are as widely spaced as possible. Satins are typically woven with low twist filament yarns.

g) Double-face satin—A double-face satin has two satin constructions, one on the face and another on the back, produced by a weave having two warps and one weft.

h) Paillette satin—A paillette stain is a weave that produces a changeable color affect.

i) Peau de soie—A peau de soie stain weave can be of a single or double construction, typically characterized by a cross-rib texture in the weft direction and a slight luster.

j) Satin-back—A satin-back fabric is characterized by a weave and/or fabric on one side and any other weave or fabric on the opposing fabric side.

k) Satin foaconne—A stain foaconne is a slightly creped fabric with small designs.

l) Slipper satin—A slipper satin is a compact satin that can be brocaded.

m) Velvet satin—A velvet satin comprises a warp-pile satin weave with a short, dense cut pile. The pile consists of a looped yarn on the fabric surface; the loop can be produced by: 1) knotting the yarn at the base of the fabric; 2) weaving the yarn over wires to produce loops at the base of the fabric and cutting the loops to produce a cut pile; or 3) weaving the warp yarn to produce a double cloth and slicing the warp yarns positioned between the two opposing cloth surfaces to produce two cut-pile fabrics.

“Spacer” generally refers to any material positioned below a decorative element. The spacer is generally adhered to the decorative element by an adhesive, such as but not limited to a hot melt adhesive. The spacer is generally smaller than the decorative element. The spacer can provide one or more of: substantially decreases, or eliminates, adhesion of the adhesive to an uneven/textured substrate and the decorative element; substantially decrease, or eliminates, telegraphing of the uneven/textured substrate surface to the decorative element; creates some rigidity and/or integrity to the decorative element so that it is one or both of substantially smooth and flat; creates some space between the uneven/textured substrate surface and the decorative element to provide one or both of a substantially smooth and flat decorative element. The spacer creates a “buffer space” between the decorative element and the uneven/textured substrate.

“Substrate” generally refers to any article to be decorated. The substrate may comprise any material. Non-limiting examples of suitable substrates comprise metallic materials, synthetic or natural polymeric materials, glass-based materials, ceramic materials, leather-based materials and combinations thereof and may or may not be stretchable and/or have elastic properties. The substrate may comprise an item of apparel, typically a stretchable, elastic, and/or bendable item of apparel. Non-limiting examples of stretchable and elastic items of apparel are jerseys, leotards, pants, shirts, blouses, leggings, socks, shoes, under garments, and accessories (such as, but not limited to, hair-bands, wrist bands, head bands, finger bands, ankle bands, finger bands, toe-bands, arm bands, and shoe-laces). The substrate may have a single surface or a plurality of surfaces. Non-limiting examples of a single-surfaced substrate are articles having one of a generally spherical, circular-donut, and elliptical-donut shapes. Non-limiting examples of substrates having a plurality of article surfaces are articles substantially resembling one of a cube, rectangular-box and tetrahedral shapes. The substrate of include one of the hook or loop component of hook and loop attachment system.

“Textile material” generally refers to one of: a woven textile material; a knitted textile material; a non-woven, non-knitted textile material; a substantially elastomeric textile material; a substantially non-elastomeric textile material; and a combination and/or mixture thereof. The textile material can be a suede-like fabric. Moreover, the textile material can be a microfiber textile material.

“Woven” generally refers to a fabric comprising at least two sets of yarn, thread, or strips, one warp (longitudinal) and one filling yarn, thread, or strip (transverse or crosswise), normally laced at substantially right angles to each other. Commonly, the yarn, thread, or strips are straight, run parallel either lengthwise (warp threads) or crosswise (weft threads). The weft yarn is commonly interlocked with the warp by passing under then over, one or more warp threads. Elasticity can be increased in woven fabrics when they are woven from yarn containing elastomeric yarn such as elastane (Lycra® from Invista or Dorlastan® from Bayer).

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a side view of a decorative article according to the prior art;

FIG. 2A is a side view of an intermediate decorative article according to the disclosure;

FIG. 2B is a top view of FIG. 2A;

FIGS. 3A-3H are side views intermediate decorative articles according to the disclosure;

FIGS. 4A-4H depict processes for making the intermediate decorative articles depicted in FIGS. 3A-3H;

FIG. 5 is a side view of an intermediate decorative article according to the disclosure; and

FIG. 6 is a side view of an intermediate decorative article according to the disclosure.

### DETAILED DESCRIPTION

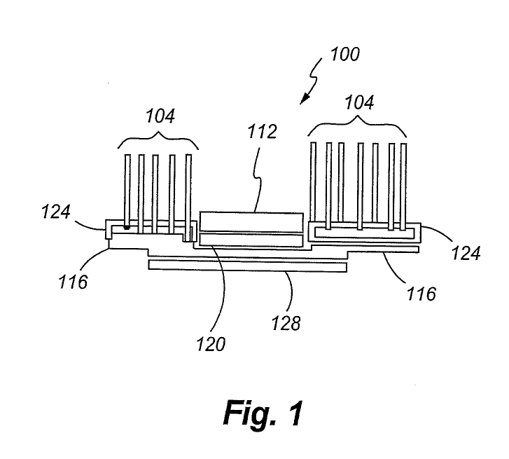

FIG. 1 shows a prior art three-dimensional design (or decorative or graphics article or product) according to U.S. Pat. No. 7,799,164 to Abrams, the entire contents of which is incorporated herein by this reference. The design 100 includes (multi-colored or sublimation printed) flocked areas 104 surrounding a plurality of compatible or noncompatible inserts 112. The inserts 112 are adhered to a porous film 116 by a first adhesive 120. Additionally, the porous film 116 is adhered to the flock areas 104 by a flock (second) adhesive 124. Finally, the design 100 is adhered to a desired substrate, such as a textile, by a permanent (third) adhesive 128.

The inserts 112 are formed from one or more polymeric light diffusing films, such as polycarbonate and/or polyester light diffusion films. The preferred inserts 112 are sold under the tradenames MAKROFOEL™ and/or BAYFOL™. The insert 112 comprises first and second polymer films (which are commonly polycarbonate films) sandwiching a metal film and laminate adhesive. The insert 112 is formed by depositing the metal film, such as by vapor deposition techniques, on the first polymer film, followed by contacting the metal film or second polymer film with the laminate adhesive, and finally laminating the first and second polymer films, metal film, and laminate adhesive together. To created desired metal appearances, the first or second polymer film can be colored, using suitable dyes or pigments or other colorants. Metal shades can be thus produced, such as brass, copper, and the like. The inserts 112 commonly have metallic or nonmetallic sheen and a gloss/fine matte. The porous film 116 is commonly a microporous material. The flock fibers in the flock layer 1104 can be any desirable material, whether natural or synthetic. Commonly, the flock is composed of polyester (such as poly(ethylene terephthalate) and poly(cyclohexylene-dimethylene terephthalate)), vinyl, nylon, rayon, and the like. The various permanent adhesives 120, 124, and 128 can be any suitable adhesive, such as water-based and solvent-based, and film adhesives.

### Mixed or Multi-Media Decorative or Graphics Articles

The decorative or graphics article of the present disclosure can have first, second and third decorative elements adhered to a carrier sheet. The article can be an appliqué, a transfer containing an appliqué, or combination thereof. Commonly, the first, second and third decorative elements are in contact with, and adhered to the carrier sheet, by a release adhesive. Generally, the carrier sheet is a substantially clear (e.g., optically or light transmissive or transparent) carrier sheet.

Each of the first, second, and third decorative elements has opposing first and second decorative element surfaces. The first and second decorative element surfaces of each of the first, second, and third decorative elements are substantially in parallel with an adjacent surface of the carrier sheet.

Each of the first, second, and third decorative elements may be selected from the group of decorative elements consisting of a metallized material, a polymeric material in the form of a film, a woven, nonwoven, or knit textile material, and flock. The first decorative element can be in contact with one or both the second and third decorative elements; the second decorative element with one or both the first and third decorative elements; and/or the third decorative element with one or both the first and second decorative elements. That is, the first decorative element can be in physical contact with one or both of the second and third decorative elements; the second decorative element with one or both of the first and third decorative elements; and/or the third decorative element with one or both of the first and second decorative elements. A void or other discontinuity may be positioned between the first decorative element and one or both of the second and third decorative elements; between the second decorative element and one or both of the first and third decorative elements; and/or between the third decorative element and one or both of the first and second decorative elements.

The first, second and third decorative elements can be in contact with one another; that is, the first, second and third decorative element can be in physical contact with one another. A void or other discontinuity, or more than one void or other discontinuity, may be positioned between the first, second and third decorative elements.

Typically, the first, second and third decorative elements differ in one or both of composition and texture. While not wanting to be limited by example, the first decorative element can be a metallized material and one or both of the second and third decorative elements, independently and separately, can be one of a textile material or flock. Typically, one or both of the textile material and flock are sublimation dyed printed. It can be appreciated that, when both of the second and third decorative elements are textile materials, the second and third decorative elements differ in one or both of composition and texture. Similarly, when both of the second and third decorative elements are flock, the second and third decorative element differ in one or both of composition and texture.

The article can have a first adhesive in contact with each of the first, second and third decorative element first surfaces. The first adhesive can be in contact with the release adhesive with the second surfaces, respectively, of the first, second and third decorative elements standing proud (or free standing), or being exposed to the viewer or free of adhesive. Alternatively, the second surfaces, respectively, of the first, second and third decorative elements can be in contact with the release adhesive with the first surfaces, respectively, of the first, second and third decorative elements standing proud (or free standing), or being exposed to the viewer or free of adhesive.

One or both of a spacer or polymeric material in the form of a film may be positioned on the first adhesive. A spacer may be positioned on the first adhesive. A polymeric material may be positioned on the first adhesive. The spacer may be positioned on some (but less than most) or most, but commonly not all, of the first adhesive. The polymeric material, in the form of a film, may be positioned on, or be in contact with, some or most, but typically not all, of the first adhesive. The spacer may be in contact with some (but less than most) or most, or all, of the adjacent surface of the first adhesive. Thus, some of the first adhesive may not contact the spacer, and some of the first adhesive may not be in contact with the polymeric film. The polymeric material may or may not be clear. Generally, the polymeric material is substantially clear but can be substantially opaque, depending on the application.

The first adhesive may be one of a thermosetting adhesive, a thermoplastic adhesive, a substantially A-staged thermosetting adhesive, a substantially B-staged thermosetting adhesive, a self-supporting adhesive film, a bi-laminate adhesive film having first and second adhesive layers, the first adhesive layer and second adhesive layer differing in one or both of chemical composition and physical properties, a tri-laminate adhesive film having a polymeric film positioned between a first adhesive film and a second adhesive film, a fast flow, low-melt adhesive, a hot-melt adhesive; and a combination and/or mixture thereof. Further regarding the tri-laminate adhesive film, the first adhesive film and second adhesive film may differ in one or both of chemical composition and physical properties, or have substantially the same chemical composition and physical properties, and the polymeric film may comprise one or more of an elastomeric material, a substantially inelastic material, clear, opaque, colored, uncolored, or a combination thereof. The polymeric film may be a tie layer.

The article can include a substrate. The substrate may be adhered to the first, second, and third decorative elements by the first adhesive.

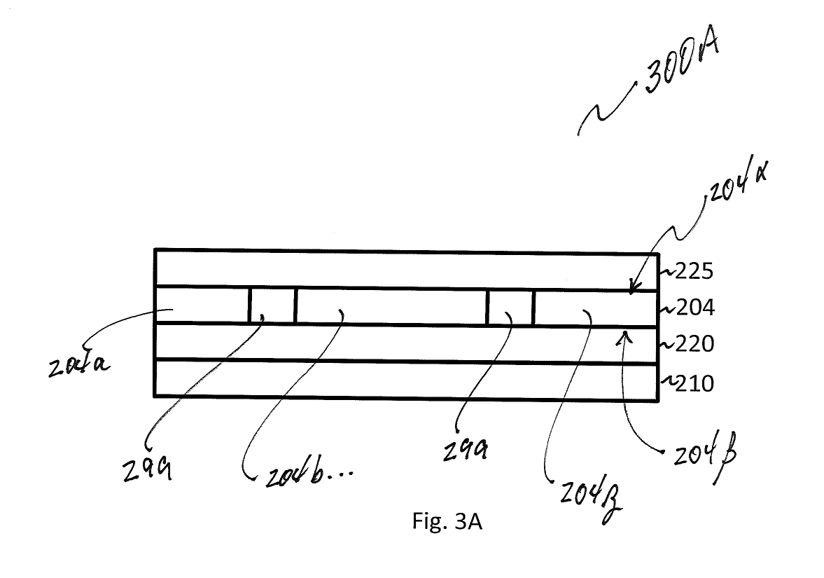

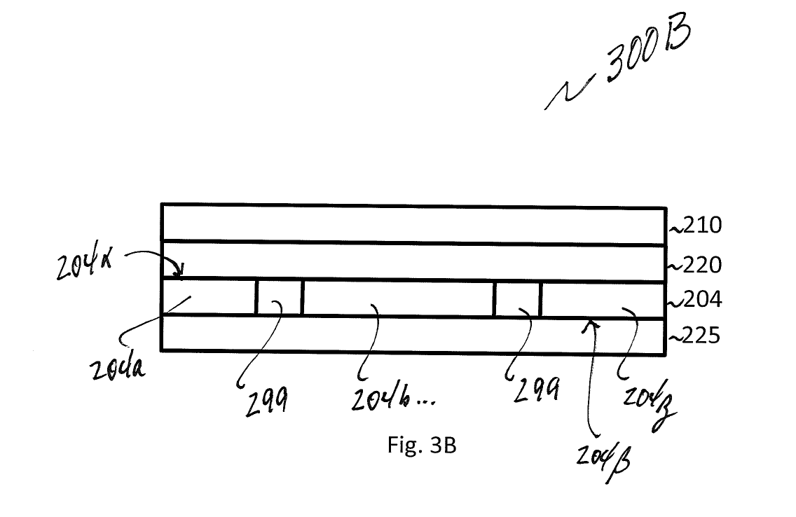

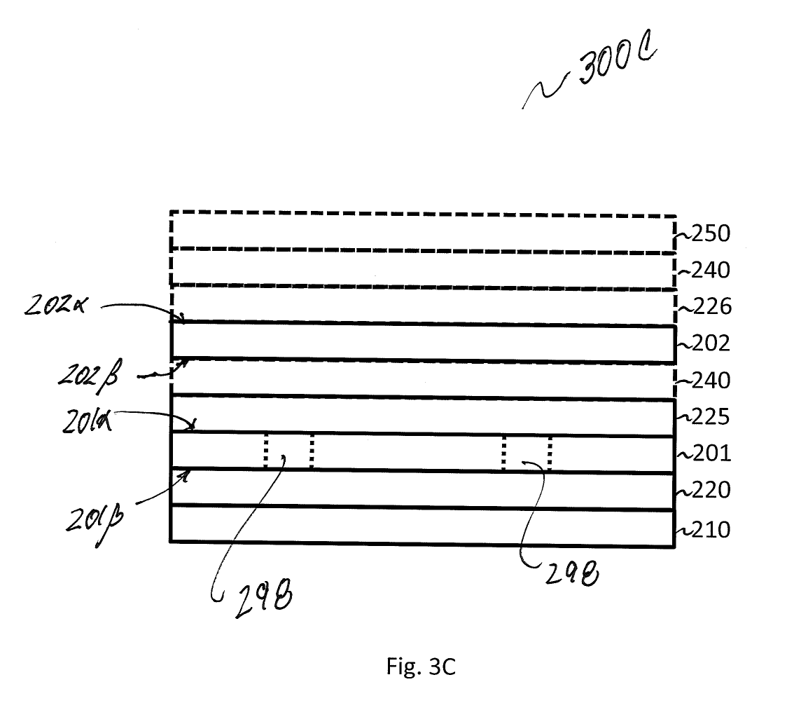

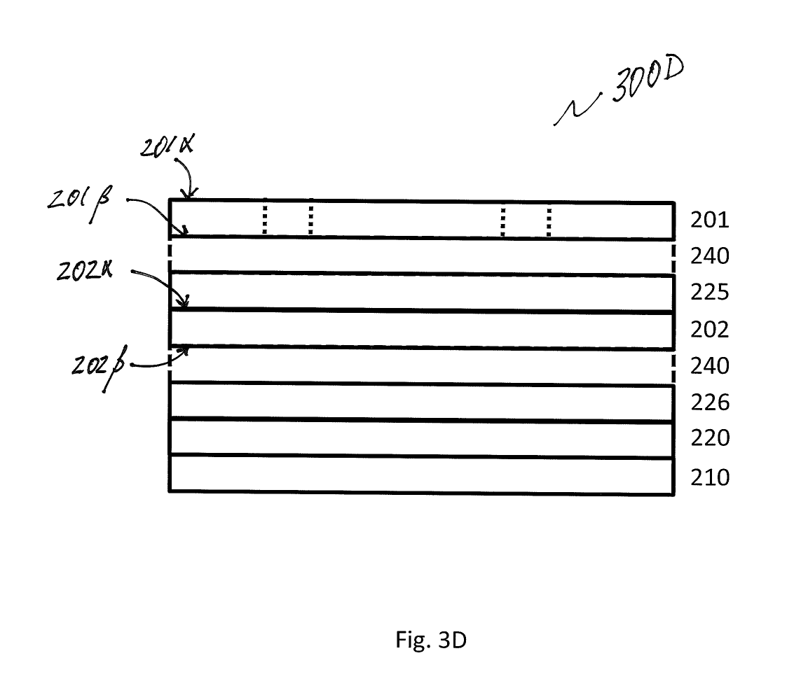

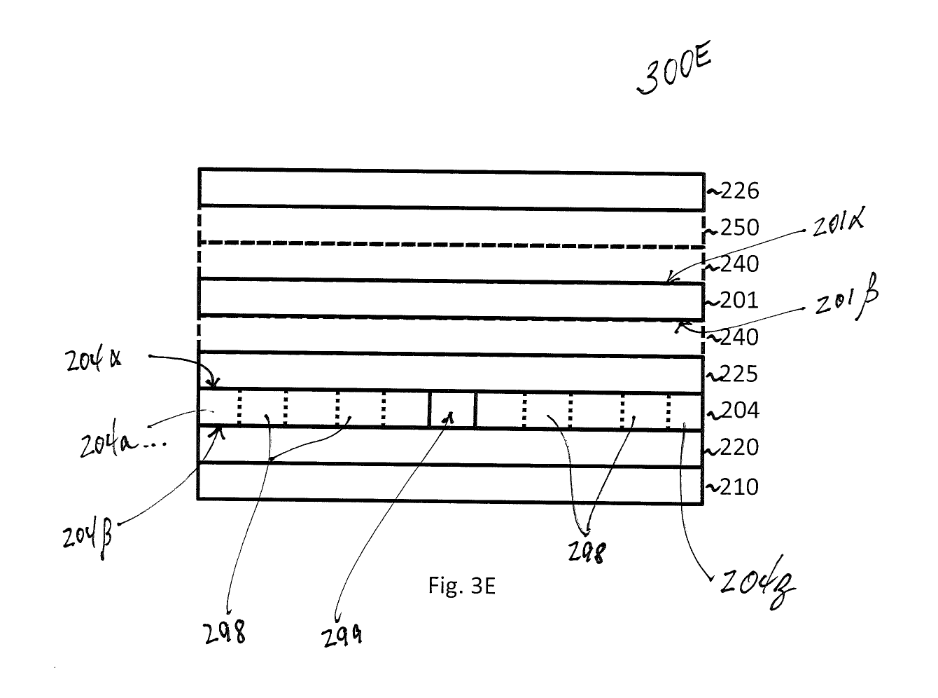

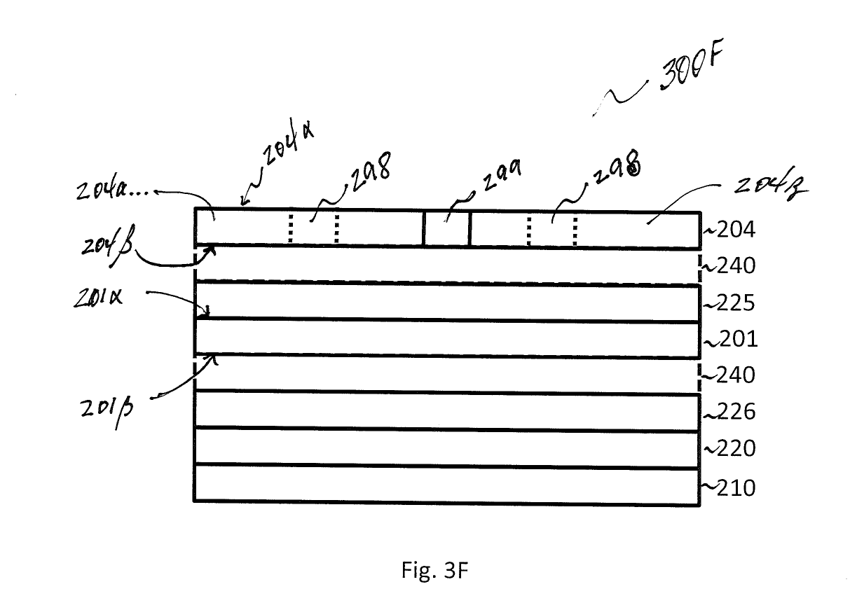

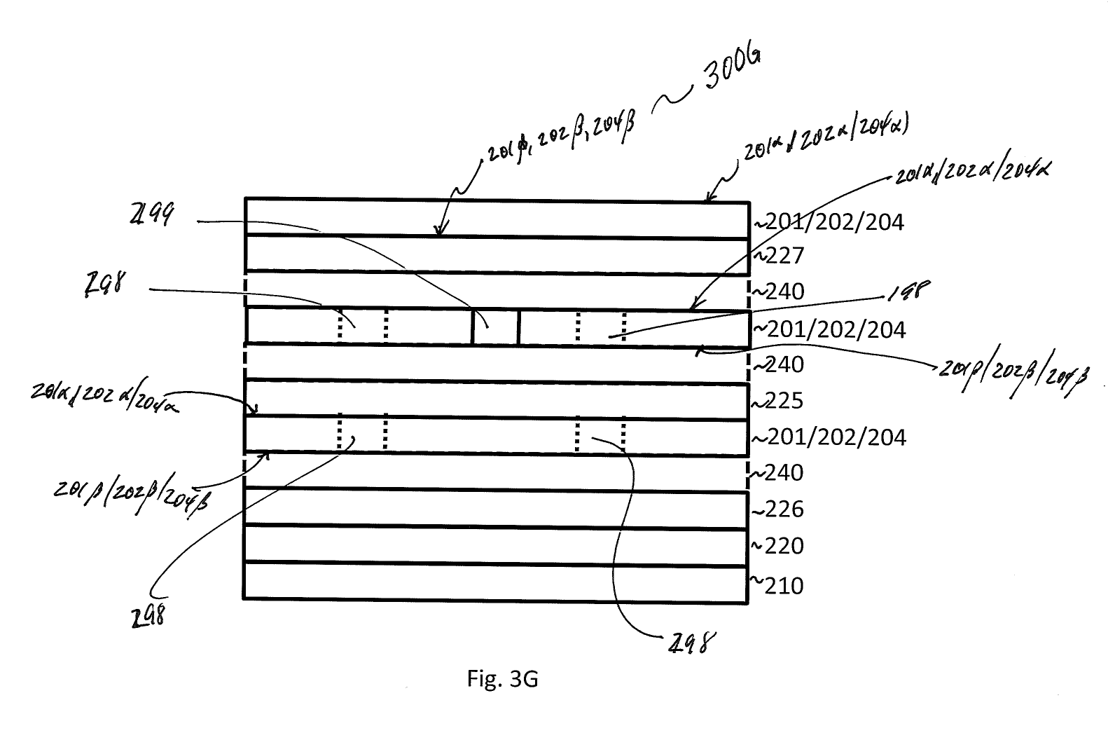

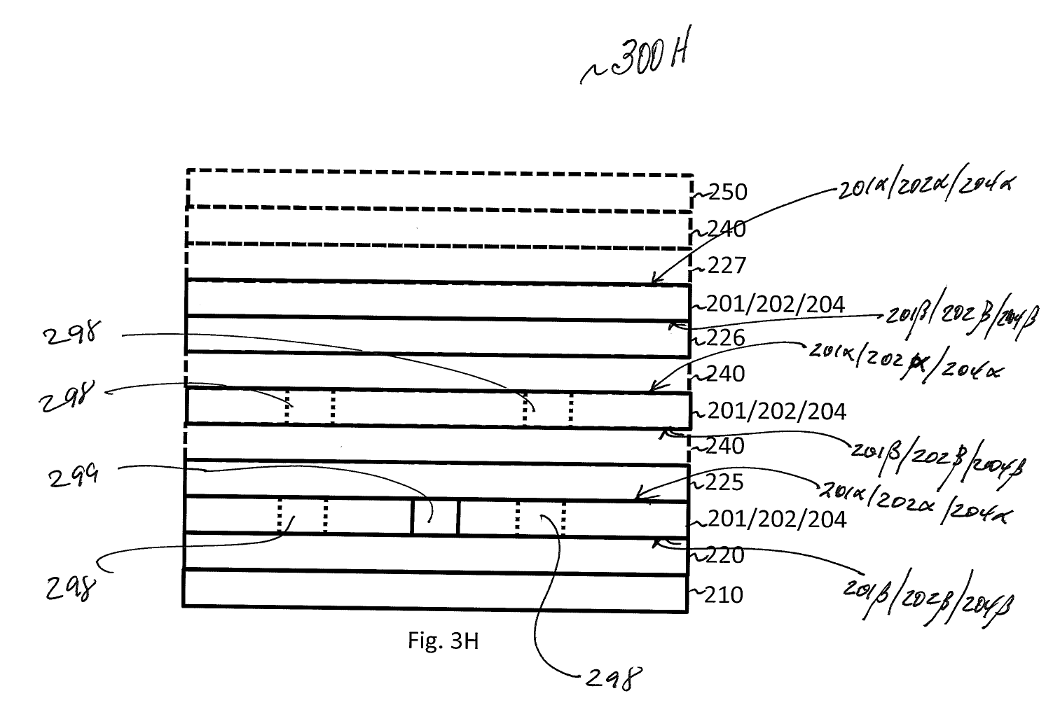

FIGS. 3A and 3B depict exemplary configurations of decorative articles 300A and 300B in accordance with the above description. The articles 300A and 300B comprise a decorative element 204 generally having one more decorative elements 204a, 204b, 204c, . . . and 204z. Each of decorative elements 204a, 204b, 204c, . . . and 204z may separately and independently be selected from the group of decorative elements consisting of a metallized material, textile material, polymeric material in the form of a film or flock. The metallized material, textile material, polymeric material in the form of a film and/or flock may be any of the respective materials described herein. One or more of the decorative elements 204a, 204b, 204c, . . . and 204z may or may not be separated by void or other discontinuities 299. The decorative element 204 commonly has opposing first 204α and second 204β surfaces.

In FIG. 3A, the decorative layer 204 is adhered to a common carrier sheet 210 by release adhesive 220. Furthermore, a first adhesive 255 may be positioned on the decorative element first surface 204α.

In FIG. 3B, the decorative element 204 is positioned on the release adhesive 220. Moreover, the decorative element second surface 204β may be positioned on the release adhesive 220. Furthermore, the first adhesive 255 may be positioned on decorative element second surface 204β.

This disclosure also relates to an article having a first decorative element adhered to a second decorative element by a first adhesive, the first and second decorative elements being adhered to a common carrier sheet by a release adhesive. The first adhesive is positioned between the first and second decorative elements. The article can be an appliqué, a transfer containing an appliqué, or combination thereof.

Typically, the first and second decorative elements differ in one or both of composition and texture. The first and second decorative elements can be selected from the group consisting of metallized materials, textile materials and polymeric materials in the form of a film. Generally, the first and second decorative elements are selected from the group consisting of metallized materials and textile materials.

The first decorative element may have an aperture or other discontinuity containing some of the second decorative element. That is, the first decorative element may have an aperture or other discontinuity, and the second decorative element may be displayed to the viewer in the aperture or other discontinuity of the first decorative element. The first decorative element may have a first areal extent and the second decorative element may have a second areal extent. Commonly, one of the first and second areal extents may extend beyond the areal extent of the other of the first and second areal extents. It can be appreciated that, for regions where the areal extents overlap, the underlying decorative element (relative to the viewer's perspective in the final product) the overlapping areal extent of the underlying decorative element can be devoid of a hue. Stated another way, the overlapping areal extent of the underlying decorative element can be devoid of one or both of color or a sublimation dye.

The first and second decorative elements can be textile materials differing in one or both of composition and texture. Commonly, the textile materials are sublimation dyed printed. The first and second decorative elements can be textile materials differing in one or both of fiber composition and textile construction. Each of the first and second decorative elements can be a textile material selected from the group consisting of woven textile materials, knitted textile materials and a non-woven, non-knitted textile materials. Commonly, each of the first and second decorative elements is one of: a woven textile material, a knitted textile material, a non-woven, non-knitted textile material, a substantially elastomeric textile material, a substantially non-elastomeric textile material, and a combination and/or mixture thereof.

The first decorative element can be a textile material having a satin weave. The second decorative element can be a textile material comprising a weave other than a satin weave.

The first decorative element can be a textile material having a weave other than a satin weave. The second decorative element can be a textile material having a satin weave.

The first decorative element can be flock. The second decorative element can be one of a metallized material or textile material. While not wanting to be limited by example, the first decorative element can be flock, and the second decorative element can be a metallized material. In another non-limiting example the first decorative element can be flock, and the second decorative element can be a textile material. One or both of the flock and textile material can be sublimation dye printed.

The first decorative element can be a metallized material. The second decorative element can be one of flock or textile material. While not wanting to be limited by example, the first decorative element can be a metallized material, and the second decorative element can be flock. In another non-limiting example the first decorative element can be a metallized material, and the second decorative element can be a textile material. The flock and textile material can be sublimation dye printed.

Generally, the article has a second adhesive. More generally, the second decorative element is positioned between the first and second adhesives. The second adhesive may be one of a thermosetting adhesive, a thermoplastic adhesive, a substantially A-staged thermosetting adhesive, a substantially B-staged thermosetting adhesive, a self-supporting adhesive film, a bi-laminate adhesive film having first and second adhesive layers, the first and second adhesive layer differing in one or both of chemical composition and physical properties, a tri-laminate adhesive film having a polymeric film positioned between a first adhesive film and a second adhesive film, a fast flow, low-melt adhesive, a hot-melt adhesive; and a combination and/or mixture thereof. Further regarding the tri-laminate adhesive film, the first adhesive film and second adhesive film may differ in one or both of chemical composition and physical properties, or have substantially the same chemical composition and physical properties and the polymeric film may comprise one or more of an elastomeric material, a substantially inelastic material, clear, opaque, colored, uncolored, or a combination thereof. The first and second adhesives may be substantially the same or may differ. The polymeric film may be a tie layer.

Each of the first and second decorative elements commonly has opposing first and second surfaces.

The second adhesive may be positioned between the second decorative element and the release adhesive. More typically, the first adhesive is positioned between the first and second decorative elements, and second adhesive between the second decorative element and the release adhesive. The first and second decorative elements are adhered to the carrier sheet by the release adhesive. Generally, the first surface of the first decorative element stands proud (or free standing), and the second surface of the first decorative element is in contact with the first adhesive. Commonly, the first surface of the second decorative element is in contact with the first adhesive, and the second surface of the second decorative element with the second adhesive.

The second adhesive may be positioned on the first surface of the second decorative element, the second surface of the second decorative element being positioned on the first adhesive. More typically, the first adhesive is positioned on second surface of the second decorative element and the first surface of the first decorative element. Even more typically, the second surface of the first decorative element is positioned on the release adhesive. Generally, the first decorative element is positioned between the release adhesive and the first adhesive. The first and second decorative elements are adhered to the carrier sheet by the release adhesive.

One or both of a spacer or polymeric material in the form of a film may be positioned on the one or both of first and second adhesives. The spacer can be positioned on the first and/or second adhesives.

A polymeric material in the form of a film may be positioned on the first and/or second adhesives.

The spacer may be positioned on some (but less than most) or most, but commonly not all, of one or both of the first and second adhesives. Generally, some of one or both of the first and second adhesives are not in contact with the spacer.

The polymeric material, in the form of a film, may be positioned on some (but less than most) or most, but commonly not all, of one or both of the first and second adhesives. Generally, some of the first adhesive is not in contact with the polymeric film. The polymeric material may or may not be clear. Generally, the polymeric material in the form of a film is substantially clear but may be substantially opaque, depending on the application.

The article can further include a substrate. Generally, the second adhesive is positioned between the substrate and the second decorative element. More generally, one or both of the spacer and polymeric material may be positioned between the substrate and the second decorative element.

The first and second adhesives may or may not differ. More generally, the first and second adhesives may separately and independently be one of a thermosetting adhesive, a thermoplastic adhesive, a substantially A-staged thermosetting adhesive, a substantially B-staged thermosetting adhesive, a self-supporting adhesive film, a bi-laminate adhesive film having first and second adhesive layers, the first adhesive layer and second adhesive layer differ in one or both of chemical composition and physical properties, a tri-laminate adhesive film having a polymeric film positioned between a first adhesive film and a second adhesive film, a fast flow, low-melt adhesive, a hot-melt adhesive; and a combination and/or mixture thereof. Further regarding the tri-laminate adhesive film, the first adhesive film and second adhesive film may differ in one or both of chemical composition and physical properties, or have substantially the same chemical composition and physical properties and the polymeric film may comprise one or more of an elastomeric material, a substantially inelastic material, clear, opaque, colored, uncolored, or a combination thereof. The polymeric film may be a tie layer.

The article can have one or more of the other decorative elements adhered to the first decorative element by a first adhesive, the first and other decorative elements being adhered to a common carrier sheet by a release adhesive. The common carrier sheet may be a substantially clear or opaque common carrier sheet. The article can be an appliqué, a transfer containing an appliqué, or combination thereof.

The other decorative elements have opposing first and second decorative element surfaces. The first and second surfaces of the other decorative elements are substantially parallel with an adjacent surface of the common carrier sheet. A void or other discontinuity may or may not be positioned between one or more of the other decorative elements. More typically, a void or other discontinuity is positioned between one or more of the other decorative elements. Even more typically, the other decorative elements are positioned adjacent to one another without a substantial void or other discontinuity between the positioned between the decorative elements.

The first decorative element may have an aperture or other discontinuity containing some of one or more of the other decorative elements. That is, the first decorative element may have an aperture or other discontinuity, and the other decorative elements may be displayed in aperture or other discontinuity of the first decorative element.

The first decorative element may have a first areal extent, and each of the other decorative elements may have areal extents. Typically, an areal extent of one of the decorative elements extends beyond the areal extent of another decorative element. It can be appreciated that, for regions where the areal extents overlap, the underlying decorative element (relative to the viewer's perspective in the final product) the overlapping areal extent of the underlying decorative element can be devoid of a hue. Stated another way, the overlapping areal extent of the underlying decorative element can be devoid of one or both of color or a sublimation dye.

The various decorative elements may be selected from the group consisting of a metallized material, a polymeric material in the form of a film, a textile material, and flock. The flock or flocks are typically sublimation dye printed flock or flocks. The textile material and/or materials are typically sublimation dye printed textile material(s). The first decorative element can be a metallized material and one or more of the other decorative elements can be selected from the group consisting of flocks and textile materials.

Commonly, one or more of the other decorative elements differs, in composition and/or texture from the first decorative element. More commonly, the first decorative element differs, in composition and/or texture, from most or all of the other decorative elements. Even more commonly, each of the decorative elements differ from one another in composition and/or texture.

The first decorative element can be a metallized material and one or more of the other decorative elements can be selected from the group consisting of flocks, polymeric materials in the form of a film, and textile materials. Generally, one or more of the other decorative elements is sublimation dye printed. More generally, the textile materials are selected from the group consisting of woven fabrics, knitted fabrics, and textile materials other than woven and knitted fabrics. Even more generally, the first decorative element can be a metallized material and one or more of the other decorative elements is selected from the group consisting of flocks and textile materials.

The first decorative element can be a first textile material and one or more of the other decorative elements can be selected from group consisting of metallized materials, polymeric materials in the form of a film, woven textile materials other than the first textile material, knitted textile materials other than the first textile material, and non-woven, non-knitted textile materials other than the first textile material. Typically, the first textile material comprises a sublimation dye printed textile material. The woven textile materials other than the first textile material can be a sublimation dye printed textile material. The knitted textile materials other than the first textile material can be a sublimation dye printed textile material. The non-woven, non-knitted textile materials other than the first textile material can be a sublimation dye printed textile material.

The first decorative element can be flock and one or more of the other decorative elements can be selected from the group consisting of metallized materials, polymeric materials in the form of a film, and textile materials. Typically, the flock is sublimation dye printed flock. Furthermore, the other decorative elements can be sublimation dye printed textile materials. More generally, the first decorative element is flock, and one or more of the other decorative elements are selected from the group consisting of metallized materials and textile materials.

The article can have the second adhesive. More generally, one of the first and other decorative elements is positioned between the first and second adhesives. Typically, the other decorative elements are positioned between the first and second adhesives. More typically, the first decorative element is positioned between the first and second adhesives.

Each of the first and other decorative elements has opposing first and second surfaces.

The second adhesive may be positioned between the other decorative elements and the release adhesive. More typically, the first adhesive is positioned between the first and the other decorative elements, and the second adhesive is positioned between the other decorative elements and the release adhesive. The first and the other decorative elements are adhered to the carrier sheet by the release adhesive. Generally, the first surface of the first decorative element stands proud (or free standing), and the second surface of the first decorative element is in contact with the first adhesive. Commonly, the first surface of the other decorative elements is in contact with the first adhesive, and the second surface of the other decorative elements with the second adhesive.

Typically, the second adhesive is positioned on the first surface of the other decorative elements, the second surface of the other decorative elements being positioned on the first adhesive. More typically, the first adhesive is positioned on the second surface of the other decorative elements and the first surface of the first decorative element. Even more typically, the second surface of the first decorative element is positioned on the release adhesive. Generally, the first decorative element is positioned between the release adhesive and the first adhesive. The first decorative element and other decorative elements are adhered to the carrier sheet by the release adhesive.

Furthermore, it can be appreciated that commonly the second adhesive may be positioned between the first decorative element and the release adhesive. More commonly, the first adhesive is positioned between the other decorative elements and the first decorative element, and the second adhesive is positioned between the first decorative element and the release adhesive. The first and other decorative elements are adhered to the carrier sheet by the release adhesive. Generally, the first surface of the other decorative elements stands proud (or free standing), and the second surface of the other decorative elements is in contact with the first adhesive. Typically, the first surface of the first decorative element is in contact with the first adhesive, and the second surface of the first decorative element is in contact with the second adhesive. Moreover, the two or more decorative elements may have one or more aperture(s) or other discontinuities. The one or more aperture(s) or other discontinuities may contain some of the first decorative element. That is, the one or more of the other decorative elements may have one or more aperture(s) or other discontinuities, and some of the first decorative element may be displayed in the one or more aperture(s) or other discontinuities of other decorative elements.

Furthermore, it can be appreciated that commonly, the second adhesive may be positioned on the first surface of the first decorative element, the second surface of the first decorative element being positioned on the first adhesive. More commonly, the first adhesive is positioned on the second surface of the first decorative element and the first surface of the other decorative elements. Even more commonly, the second surface of the other decorative elements is positioned on the release adhesive. Generally, the other decorative elements are positioned between the release adhesive and the first adhesive. The first and other decorative elements can be adhered to the carrier sheet by the release adhesive. Moreover, the other decorative elements may have one or more aperture or other discontinuities. The one or more aperture or other discontinuities may contain some of the first decorative element. That is, the one or more of the other decorative elements may have one or more aperture or other discontinuities, and some of the first decorative element may be displayed in the one or more aperture or other discontinuities of other decorative elements.

One or both of the spacer or polymeric material in the form of a film may be positioned on the one or both of first and second adhesives.

The spacer may be positioned on the first adhesive. Even more generally, the spacer is positioned on the second adhesive. Yet even more generally, the spacer is positioned on first and second adhesives.

The polymeric material in the form of a film may be positioned on the first adhesive. More typically, the polymeric material is positioned on the second adhesive. Even more typically, a polymeric material is positioned on first and second adhesives.

The spacer may be positioned on some (but less than most) or most, but commonly not all, of one or both of the first and second adhesives. Commonly, the spacer is in contact with at least part of one or both of the first and second adhesives. More commonly, the spacer is in contact with most of one or both of the first and second adhesives. Even more commonly, the spacer is in contact with most, but not all, of one or both of the first and second adhesives. Thus, some of one or both of the first and second adhesives are not in contact with the spacer.

The polymeric material in the form of a film may be positioned on some (but not most) or most, but commonly not all, of one or both of the first and second adhesives. Typically, the polymeric material is in contact with some of the first adhesive. More typically, the polymeric material is in contact with most of the first adhesive. Even more typically, the polymeric material is in contact with most, but not all, of the first adhesive. Generally, some of the first adhesive is not in contact with the polymeric film. The polymeric material may or may not be substantially clear. Generally, the polymeric material in the form of a film is substantially clear. More generally, the polymeric material in the form of a film is substantially opaque.

The article can further include a substrate. Generally, the second adhesive is positioned between the substrate and one of the decorative elements. More generally, one or both of the spacer and polymeric material is positioned between the substrate and one of the decorative elements.

Commonly, the second adhesive is positioned between the substrate and the first decorative element. More commonly, one or both of the spacer and polymeric material is positioned between the substrate and the first decorative element. Even more commonly, the spacer is positioned between the substrate and the first decorative element. More commonly, the polymeric material is positioned between the substrate and the first decorative element.

Typically, the second adhesive is positioned between the substrate and the other decorative elements. More commonly, one or both of the spacer and polymeric material is positioned between the substrate and the other decorative elements. Even more commonly, the spacer is positioned between the substrate and the other decorative elements. More commonly, the polymeric material is positioned between the substrate and the other decorative elements.

A number of examples of decorative articles including features described above will not be discussed.

The articles 300C and 300D (discussed below in connection with FIGS. 3C and 3D) comprise a decorative element 201 adhered to second decorative element 202 by a first adhesive 225. The first and second decorative elements may separately and independently be selected from the group of decorative elements consisting of a metallized material, textile material, polymeric material in the form of a film or flock. The metallized material, textile material, polymeric material in the form of a film and/or flock may be any of the respective materials described herein.

FIG. 3C depicts an exemplary configuration of article 300C. In FIG. 3C, the first decorative element 201 is positioned on the release adhesive 220. The release adhesive is positioned between a carrier sheet 210 and the first decorative element 201. Generally, the first decorative element may have one or more aperture(s) or other discontinuities 298. The first decorative element commonly has opposing first 201α and second 201β surfaces. Typically, the first decorative element second surface 201β is positioned on the release adhesive 220. The first adhesive 225 is generally positioned between the first 201 and second 202 decorative elements. More commonly, one or both of a spacer and/or polymeric material in the form of a film 240 may be positioned on the first adhesive 225 and positioned between the first 201 and second 202 decorative elements.

The second decorative element typically has opposing first 202α and second 202β surfaces. Generally the second decorative element second surface 202β is positioned on the first adhesive. More generally, a second adhesive 226 is positioned on the second decorative element first surface 202α. Typically, one or both of a spacer and/or polymeric material in the form of a film 240 may be positioned on the second adhesive 226.

Generally, a substrate 250 may be adhered to the second adhesive 226. Typically, the second adhesive 226 is positioned between the substrate 250 and the second decorative element.

The article can further include multiple adhesives, namely the first and a third adhesive, adhering different ones of the decorative elements to the first decorative element. The other decorative elements may be laminated, by the third or a fourth adhesive, one on top of the other. The third and fourth adhesives can have the same or different composition and/or properties as the first and/or second adhesives and be any of the adhesives referenced above as being suitable for the first and second adhesives. When laminated, the decorative elements can have opposing first and second surfaces for contacting any one or more of the release adhesive, first adhesive, second adhesive and third adhesive as described in the preceding paragraphs and the paragraphs following.

The first, second and third decorative elements stacked on top of the other can be adhered to a common carrier sheet by a release adhesive. In the stacked configuration, the second decorative element is adhered to the first decorative element by the first adhesive and to the third decorative element by the second adhesive. In other words, the second decorative element is positioned between the first and third decorative elements. The common carrier sheet is typically substantially clear and/or optically transparent.

The first decorative element may have a first aperture or other discontinuity containing all or part of one or both of the second and third decorative elements. The second decorative element may have a second aperture or other discontinuity containing all or part of the third decorative element. Typically, the first aperture or other discontinuity is larger than second aperture or other discontinuity. In other words, par or all of the second and third decorative elements may be viewed through the aperture or other discontinuity in the first decorative element. Thus, first decorative element may have a first areal extent and the second and third decorative elements, respectively, second and third areal extents. Typically, one or more of the first, second and third areal extents may extend beyond the areal extent of the other of the first, second and third areal extents. It can be appreciated that, for regions where the areal extents overlap, the underlying decorative element (relative to the viewer's perspective in the final product) the overlapping areal extent of the underlying decorative element can be devoid of a hue. Stated another way, the overlapping areal extent of the underlying decorative element can be devoid of one or both of color or a sublimation dye.

The first, second and third decorative elements can be independently and separately selected from the group consisting of metallized materials, polymeric materials in the form of a film, textile materials and flock.

Two or more of the first, second and third decorative elements can be textile materials differing in one or both of composition and texture. Furthermore, one or more of the first, second and third decorative elements can sublimation dye printed textile materials.

The first decorative element can be a textile material. Commonly, the textile material has a satin weave. More commonly, one or both of the second and third decorative elements are textile materials having a weave other than a satin weave.

The first decorative element can be a textile material having a weave other than a satin weave and one or both of the second and third decorative elements comprise a textile material comprising a satin weave.

The first decorative element comprises one of the metallized material or flock. The second and third decorative elements are textile materials differing in one or both of fiber composition and textile construction. One or more of the flock and second and third decorative elements can be sublimation dye printed. The second and third decorative elements can be a textile material selected from the group consisting of woven textile materials, a knitted textile material, and a non-woven, non-knitted textile material.

Generally, the first decorative element can be flock and the second and third decorative elements can be selected from the group consisting of metallized materials, polymeric materials in the form of a film, and textile materials. More generally, the first decorative element can be flock and the second and third decorative elements can be selected from the group consisting of metallized materials and textile materials. The first decorative element can sublimation dye printed flock. One or both of the second and third decorative elements can be sublimation dye printed textile materials.

Generally, the first decorative element can be a metallized material and the second and third decorative elements can be selected from the group consisting of flocks, polymeric materials in the form of a film, and textile materials. More generally, the first decorative element can be a metallized material and the second and third decorative elements can be selected from the group consisting of flocks and textile materials. One or both of the second and third decorative elements can be sublimation dye printed.

Each of the first, second, and third decorative elements has opposing first and second surfaces. Generally, the first adhesive is in contact with the second surface of the first decorative element and the first surface of the second decorative element, and the second adhesive with the second surface of the second decorative element and the first surface of the third decorative element. The first surface of first decorative element can stand proud (or free standing). The second surface of the third decorative element can be in contact with a third adhesive, and the third adhesive with the release adhesive.

The first adhesive can be in contact with the first surface of the first decorative element and the second surface of the second decorative element, and the second adhesive with the first surface of the second decorative element and the second surface of the third decorative element. The first surface of the third decorative element can stand proud (or free standing). The second surface of the first decorative can be in contact with the release adhesive. The third adhesive can be in contact with one of the first surface of the first decorative element or with the first surface of the third decorative element.

The article can include the substrate. The substrate may be adhered to the first surface of the first decorative element by the third adhesive. The third adhesive can be in contact with the substrate and the first surface of the first decorative element. Moreover, the substrate may be adhered to the first surface of third decorative element by a third adhesive. The third adhesive can be in contact with the substrate and the first surface of the third decorative element.

One or both of the spacer or polymeric material in the form of a film may be positioned on one or more of the first, second and third adhesives. The spacer may be positioned on one or more of the first, second and third adhesives. The polymeric material may be positioned on one or more of the first, second and third adhesives. The spacer may be positioned on, or be in contact with, some (but less than most) or most, but commonly not all, of one or more of the first, second or third adhesives. Generally, one or more of the first, second or third adhesives is not in contact with the spacer. The polymeric material may be positioned on, or be in contact with, some (but less than most) or most, but typically not all, of one or more of the first, second or third adhesives. Generally, one or more of the first, second or third adhesives is not in contact with the polymeric film. The polymeric material may or may not be substantially clear or substantially opaque.

The third and fourth adhesives may be independently and separately one of a thermosetting adhesive, a thermoplastic adhesive, a substantially A-staged thermosetting adhesive, a substantially B-staged thermosetting adhesive, a self-supporting adhesive film, a bi-laminate adhesive film having first and second adhesive layers, the first adhesive layer and second adhesive layer differing in one or both of chemical composition and physical properties, a tri-laminate adhesive film having a polymeric film positioned between a first adhesive film and a second adhesive film, a fast flow, low-melt adhesive, a hot-melt adhesive; and a combination and/or mixture thereof. Further regarding the tri-laminate adhesive film, the first adhesive film and second adhesive film may differ in one or both of chemical composition and physical properties, or have substantially the same chemical composition and physical properties and the polymeric film may comprise one or more of an elastomeric material, a substantially inelastic material, clear, opaque, colored, uncolored, or a combination thereof. The polymeric film may be a tie layer. It can be appreciated that the first, second and/or third adhesives may be the same or may differ.

FIG. 3D depicts an exemplary configuration of article 300D as described above. Returning to FIG. 3D, the second adhesive 226 is positioned on the release adhesive 220. Generally, the release adhesive 220 is positioned between a carrier sheet 210 and the second adhesive 226. Typically, one or both of a spacer and/or polymeric material in the form of a film 240 may be positioned on the second adhesive 226.

The second decorative element 202 is generally positioned between the first 225 and second 226 adhesives. The first decorative element commonly has opposing first 201α and second 201β surfaces. The second decorative element typically has opposing first 202α and second 202β surfaces. Generally, the second decorative element second surface 202β is positioned on the second adhesive 226. Furthermore, the second decorative element first surface 202α is positioned on the first adhesive 225. Moreover, the first adhesive is in contact with the first decorative element second surface 201β and the second decorative element first surface 201α. More commonly, one or both of a spacer and/or polymeric material in the form of a film 240 may be positioned on the first adhesive 225 and positioned between the first 201 and second 202 decorative elements. Generally, the first decorative element 201 may have one or more aperture or other discontinuities 298.

It can be appreciated that in article 300C, decorative elements 201 and 202 can be interchanged, that is decorative element 201 positioned between release adhesive 220 and the first adhesive 225 can be replaced with decorative element 202. Similarly, decorative element 202 can be replaced with decorative element 201. It can be further appreciated that decorative element 202 may or may not have one or more apertures 298.

It can be appreciated that in article 300D, decorative elements 201 and 202 can be interchanged, that is decorative element 201 positioned between release adhesive 220 and the first adhesive 225 can be replaced with decorative element 202. Similarly, decorative element 202 can be replaced with decorative element 201. It can be further appreciated that decorative element 202 may or may not have one or more apertures 298.

Articles 300E and 300F illustrate further exemplary configurations. Referring to FIGS. 3E and 3F, the articles comprise a decorative element 201 adhered to two or more decorative elements 204 by a first adhesive 225. The two or more decorative elements 204 generally comprise decorative elements 204a, 204b, 204c, . . . and 204z. Each of decorative elements 204a, 204b, 204c, . . . and 204z may separately and independently be selected from the group of decorative elements consisting of a metallized material, textile material, polymeric material in the form of a film or flock. The metallized material, textile material, polymeric material in the form of a film and/or flock may be any of the respective materials described herein. One or more of the decorative elements 204a, 204b, 204c, . . . and 204z may or may not be separated by void or other discontinuities 299. Moreover, the one or more of the decorative elements 204a, 204b, 204c, . . . and 204z may or may not have aperture or other discontinuities 298. The two or more decorative elements 204 commonly have opposing first 204α and second 204β surfaces.

In FIG. 3E, the two or more decorative elements 204 are positioned on the release adhesive 220. Generally, the release adhesive 220 is positioned between a carrier sheet 210 and the two or more decorative elements 204. Typically, the two or more decorative elements second surface 204β is positioned on the release adhesive 220. The first adhesive 225 is generally positioned between the first decorative element 201 and two or more decorative elements 204. More commonly, one or both of a spacer and/or polymeric material in the form of a film 240 may be positioned on the first adhesive 225. Even more commonly, the one or both of a spacer and/or polymeric material in the form of a film 240 may be positioned between the first decorative element 201 and the two or more decorative elements 204 decorative elements.

The first decorative element 201 typically has opposing first 201α and second 201β surfaces. Generally, the first decorative element second surface 201β is positioned on the first adhesive. More generally, a second adhesive 226 is positioned on the first decorative element first surface 201α. Typically, one or both of a spacer and/or polymeric material in the form of a film 240 may be positioned on the second adhesive 226.

Generally, a substrate 250 may adhered to the second adhesive 226. Typically, the second adhesive 226 is positioned between the substrate 250 and the first decorative element 201.

In FIG. 3F, the second adhesive 226 is positioned on the release adhesive 220. The release adhesive 220 is generally positioned between a carrier sheet 210 and the second adhesive 226. Commonly, one or both of a spacer and/or polymeric material in the form of a film 240 may be positioned on the second adhesive 226. More commonly, the one or both of a spacer and/or polymeric material in the form of a film 240 may be positioned between the first decorative element 201 and the second adhesive 226.

Generally, the first decorative element 201 is positioned on the second adhesive 226. The first decorative element 201 typically has opposing first 201α and second 201β surfaces. Generally, the first decorative element second surface 201β is positioned on the second adhesive 226.

The first decorative element 201 is typically positioned between the first 225 and second 226 adhesives. The first adhesive 225 is generally positioned on the first decorative element first surface 201α. Commonly, one or both of a spacer and/or polymeric material in the form of a film 240 may be positioned on the first adhesive 225. More commonly, the one or both of a spacer and/or polymeric material in the form of a film 240 may be positioned between the first decorative element 201 and the two or more decorative elements 204 decorative elements.

Generally, the two or more decorative elements 204 are positioned on the first adhesive 225. The two or more decorative elements 204 commonly have opposing first 204α and second 204β surfaces. More generally, the two or more decorative elements second surface 204β is in contact with the first adhesive 225. Typically, one or both of a spacer and/or polymeric material in the form of a film 240 may be positioned on the first adhesive 225. More typically, the one or both of a spacer and/or polymeric material in the form of a film 240 may be positioned between the first adhesive 225 and the two or more decorative elements 204.

It can be appreciated that in article 300E, decorative elements 201 and 204 can be interchanged, that is decorative element 204 positioned between release adhesive 220 and the first adhesive 225 can be replaced with decorative element 201. Similarly, decorative element 201 can be replaced with decorative element 204. It can be further appreciated that decorative element 201 may or may not have one or more apertures 298. Moreover, decorative element 204 may or may not have apertures 298.

It can be appreciated that in article 300F, decorative elements 201 and 204 can be interchanged, that is decorative element 201 positioned between release adhesive 220 and the first adhesive 225 can be replaced with decorative element 204. Similarly, decorative element 204 can be replaced with decorative element 201. It can be further appreciated that decorative element 201 may or may not have one or more apertures 298. Moreover, decorative element 204 may or may not one or more apertures 298.

FIG. 3D depicts an exemplary configuration of article 300D as described above. Returning to FIG. 3D, the second adhesive 226 is positioned on the release adhesive 220. Generally, the release adhesive 220 is positioned between a carrier sheet 210 and the second adhesive 226. Typically, one or both of a spacer and/or polymeric material in the form of a film 240 may be positioned on the second adhesive 226.

The second decorative element 202 is generally positioned between the first 225 and second 226 adhesives. The first decorative element commonly has opposing first 201α and second 201β surfaces. The second decorative element typically has opposing first 202α and second 202β surfaces. Generally, the second decorative element second surface 202β is positioned on the second adhesive 226. Furthermore, the second decorative element first surface 202α is positioned on the first adhesive 225. Moreover, the first adhesive is in contact with the first decorative element second surface 201β and the second decorative element first surface 201α. More commonly, one or both of a spacer and/or polymeric material in the form of a film 240 may be positioned on the first adhesive 225 and positioned between the first 201 and second 202 decorative elements. Generally, the first decorative element 201 may have one or more aperture or other discontinuities 298.

It can be appreciated that in article 300C, decorative elements 201 and 202 can be interchanged, that is decorative element 201 positioned between release adhesive 220 and the first adhesive 225 can be replaced with decorative element 202. Similarly, decorative element 202 can be replaced with decorative element 201. It can be further appreciated that decorative element 202 may or may not have one or more apertures 298.

It can be appreciated that in article 300D, decorative elements 201 and 202 can be interchanged, that is decorative element 201 positioned between release adhesive 220 and the first adhesive 225 can be replaced with decorative element 202. Similarly, decorative element 202 can be replaced with decorative element 201. It can be further appreciated that decorative element 202 may or may not have one or more apertures 298.

The articles 300G and 300H (discussed below in connection with FIGS. 3G and 3H) comprise a decorative element 201 (or alternatively 202 or 204) adhered to second decorative element 202 (or alternatively 201 or 204) by a first adhesive 225, and a third decorative element 204 (or alternatively 201 or 202) may adhered to the second decorative element 202 (or alternatively 201 or 204) by a second adhesive 226. The first, second and third decorative elements may separately and independently be selected from the group of decorative elements consisting of a metallized material, textile material, polymeric material in the form of a film or flock. The metallized material, textile material, polymeric material in the form of a film and/or flock may be any of the respective materials described herein.

FIG. 3G depicts an exemplary configuration of article 300G. In FIG. 3G, the first decorative element 201 is positioned on the second adhesive 226. The second adhesive 226 is positioned between a release adhesive 220 and the first decorative element 201. Generally, the first decorative element may have one or more aperture(s) or other discontinuities 298. The first decorative element commonly has opposing first 201α and second 201β surfaces. Typically, the first decorative element second surface 201β is positioned on the second adhesive 226. The first adhesive 225 is generally positioned between the first 201 and second 202 decorative elements. More commonly, one or both of a spacer and/or polymeric material in the form of a film 240 may be positioned on the first adhesive 225 and positioned between the first 201 and second 202 decorative elements. Generally, the second decorative element 202 may have one or more aperture(s) or other discontinuities 298. The second decorative element 202 commonly has opposing first 202α and second 202β surfaces. Typically, the second decorative element second surface 202β is positioned on the first adhesive 225. The third adhesive 227 is generally positioned between the second 202 and third 204 decorative elements. More commonly, one or both of a spacer and/or polymeric material in the form of a film 240 may be positioned on the third adhesive 227 and positioned between the second 202 and third 204 decorative elements.

The third decorative element 204 typically has opposing first 204α and second 204β surfaces. Generally the third decorative element second surface 204β is positioned on the third adhesive 227. Typically, one or both of a spacer and/or polymeric material in the form of a film 240 may be positioned on the third adhesive 227.

FIG. 3H depicts an exemplary configuration of article 300H. In FIG. 3H, the first decorative element 201 is positioned on the release adhesive 220. The first decorative element is positioned between a release adhesive 220 and the second decorative element 202. Generally, the first decorative element may have one or more aperture(s) or other discontinuities 298. The first decorative element commonly has opposing first 201α and second 201β surfaces. Typically, the first decorative element second surface 201β is positioned on the release adhesive 220. The first adhesive 225 is generally positioned between the first 201 and second 202 decorative elements. More commonly, one or both of a spacer and/or polymeric material in the form of a film 240 may be positioned on the first adhesive 225 and positioned between the first 201 and second 202 decorative elements. Generally, the second decorative element 202 may have one or more aperture(s) or other discontinuities 298. The second decorative element 202 commonly has opposing first 202α and second 202β surfaces. Typically, the second decorative element second surface 202β is positioned on the second adhesive 226. The second adhesive 226 is generally positioned between the second 202 and third 204 decorative elements. More commonly, one or both of a spacer and/or polymeric material in the form of a film 240 may be positioned on the second adhesive 226 and positioned between the second 202 and third 204 decorative elements. Generally, the second decorative element 202 may have one or more aperture(s) or other discontinuities 298.

The third decorative element 204 typically has opposing first 204α and second 204β surfaces. Generally the third decorative element second surface 204β is positioned on the second adhesive 226. Typically, one or both of a spacer and/or polymeric material in the form of a film 240 may be positioned on the third adhesive 227.

A third adhesive (not depicted) may be positioned on third decorative element. A substrate may be adhered to the third decorative element. The third adhesive can be positioned between the third decorative element and the substrate.

Methods of Manufacturing Decorative Articles

A method to manufacture decorative articles, as described above, can include: providing a transfer sheet having the first surface of the first decorative element adhered to a common carrier sheet by a release adhesive and adhering, by a first adhesive, the first surface of the second decorative element to the second surface of the first decorative element. As discussed, each of the first and second decorative elements have opposing first and second surfaces. The first and second decorative elements can differ by one or both of composition and texture. The second decorative element can be adhered to first decorative element by a first adhesive. The carrier sheet can have one or more registering elements to aid in positioning of the first decorative element on the carrier sheet. The first surface of the second decorative element is contacted with the first adhesive and one or both heat and pressure applied one or more of before, during, and after the contacting of the second decorative element with the first adhesive.

The method can further include one or more of: 1) contacting, prior to adhering the first surface of the second decorative element to the second surface of the first decorative element, the first adhesive with the second surface of the first decorative element; 2) contacting, one or both of thereafter and during the contacting of the first adhesive with the second surface of the first decorative element, the first surface of the second decorative element with the first adhesive; and 3) applying one or both of heat and pressure before, during, and/or after the contacting of the adjacent surfaces of the first and second decorative elements with the first adhesive. The contacting of the first adhesive with first decorative element first surface may further one or more of: i) screen-printing the first adhesive on the first surface of the first decorative element; ii) contacting the first adhesive in the form of a self-supporting first adhesive film with the first surface of the first decorative element; iii) spraying the first adhesive on the first surface of first decorative element; iv) depositing the first adhesive, in particulate form, on the first surface of the first decorative element; or v) a combination thereof.

The method may further include, before the contacting of the second decorative element with the first adhesive, contacting the spacer with some (but less than most) or most, but not all, of the first adhesive.

The method may further include one or more of: providing the common carrier sheet with one or more registering elements and release adhesive; registering the first decorative element with the one or more registering elements; contacting the first decorative element with the release adhesive in registration with the common carrier sheet; and adhering the first decorative element to the release adhesive of the common carrier sheet.

The method may further include one or both of registering, before adhering the first decorative element to the second decorative element, the second decorative element with the one or more registering elements and contacting the second decorative element with the first decorative element.

The first and second decorative elements can be one of a metallized material, a textile material, or flock. If the first and second decorative elements comprise metallized materials, the first decorative element metallized material differs in one or both of form and composition from the second decorative element metallized material. If the first and second decorative elements comprise textile materials, the first decorative element textile material differs in one or more of composition, texture and form from the second decorative element textile material. Typically, one but not the other of the first and second decorative elements is a flock decorative element.

The first decorative element can be a metallized material, and the second decorative element one of a textile material or flock.

The first decorative element can be a textile material, and the second decorative element can be one of a metallized material, another textile material having one or more of differing composition, texture and form than the textile material of the first decorative element, or flock.

The first decorative element can be flock, and the second decorative element one of a metallized material or a textile material.

The method can further include: contacting a second adhesive with the second surface of the second decorative element and one or more of: screen-printing the second adhesive on the second decorative element second surface; contacting the second adhesive in the form of a self-supporting second adhesive film with the second decorative element second surface; spraying the second adhesive on the second decorative element second surface; depositing the second adhesive, in particulate form, on the second decorative element second surface; or a combination thereof.

The spacer may be contacted with some (but less than most) or most, but not all, of the second adhesive.

The method may further include one or both of: contacting the second adhesive with a substrate and adhering the first and second decorative elements to the substrate.

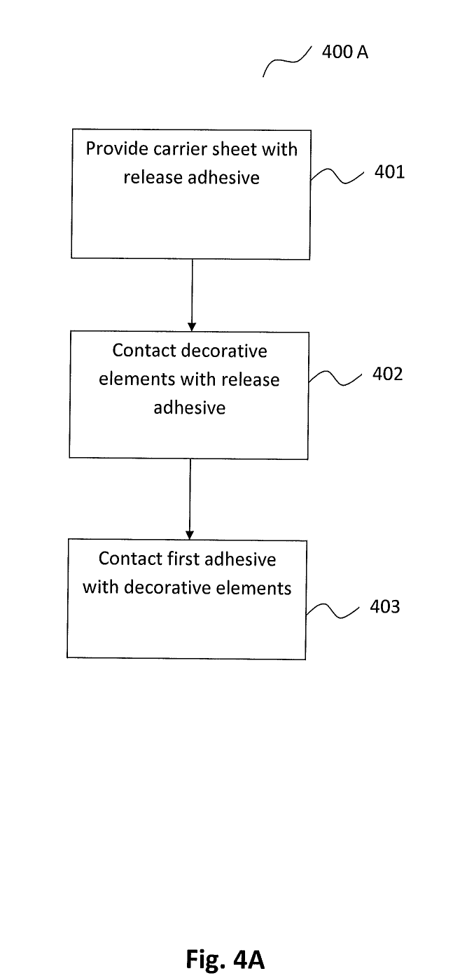

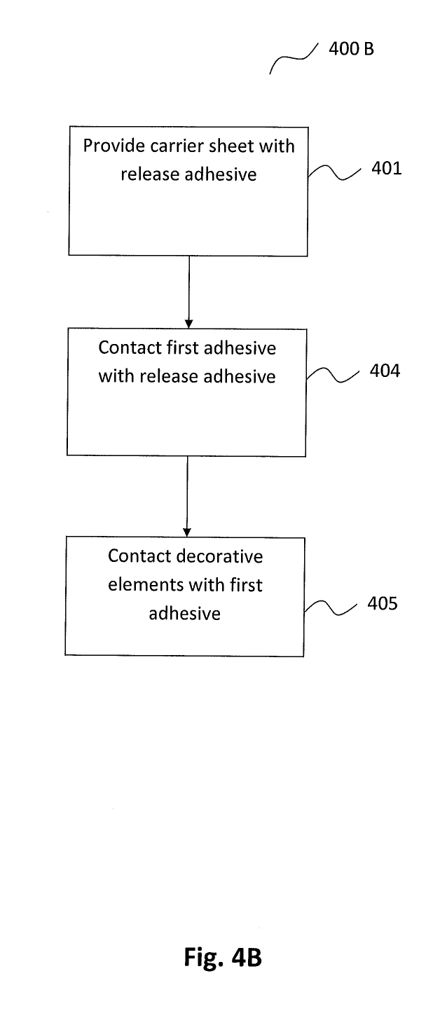

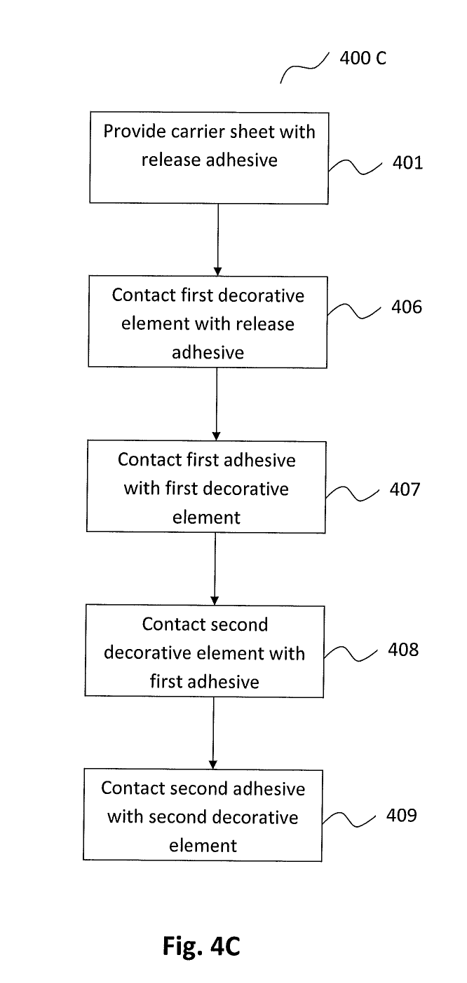

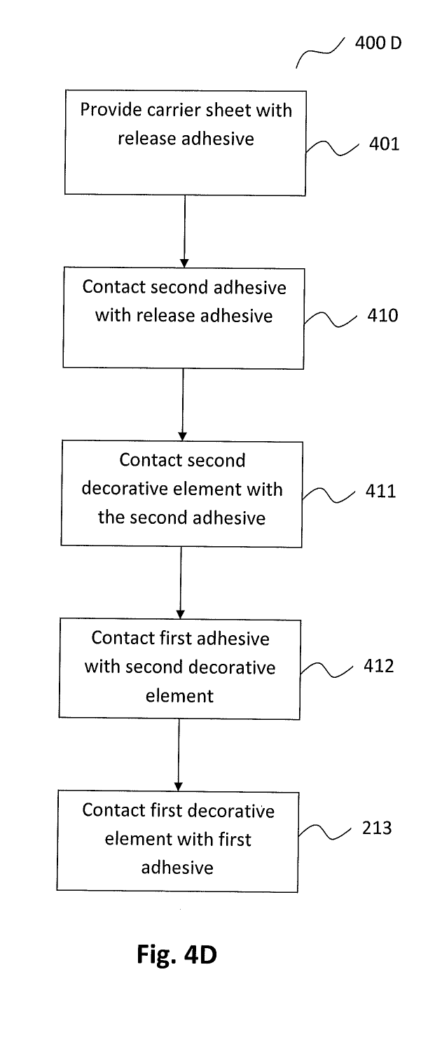

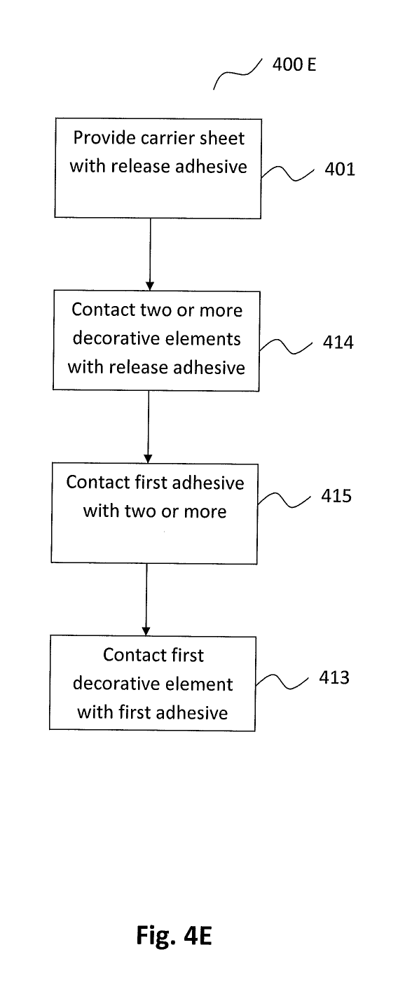

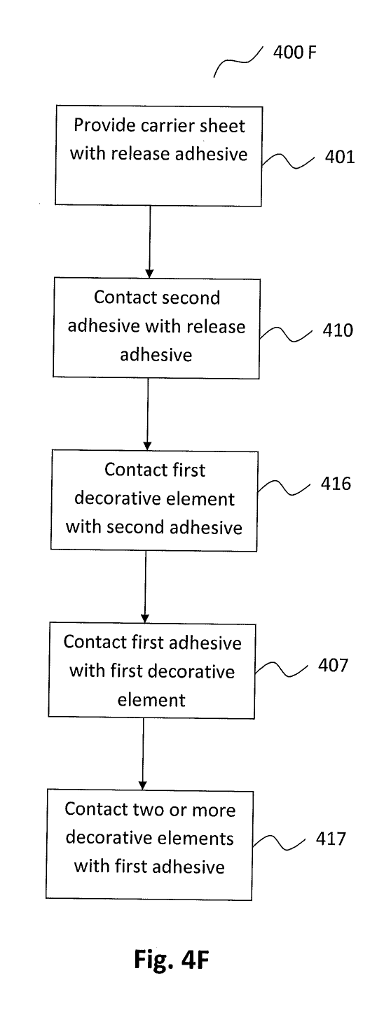

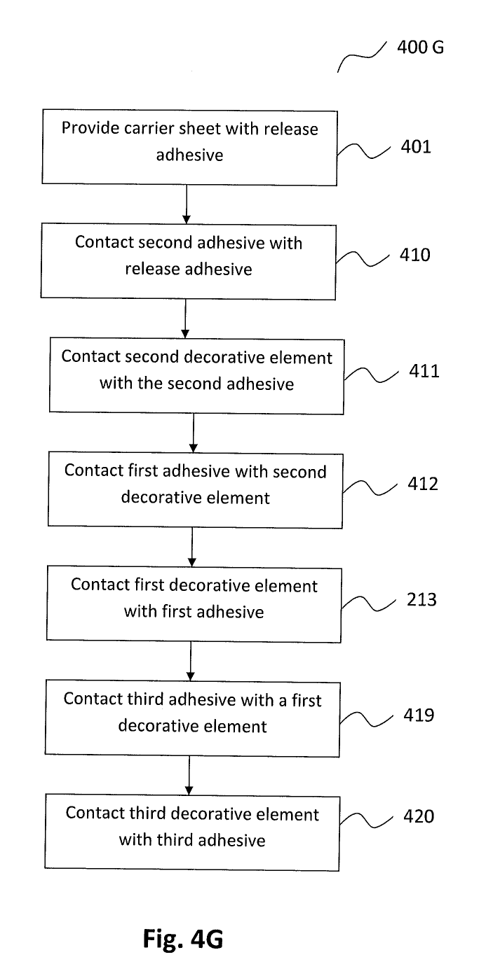

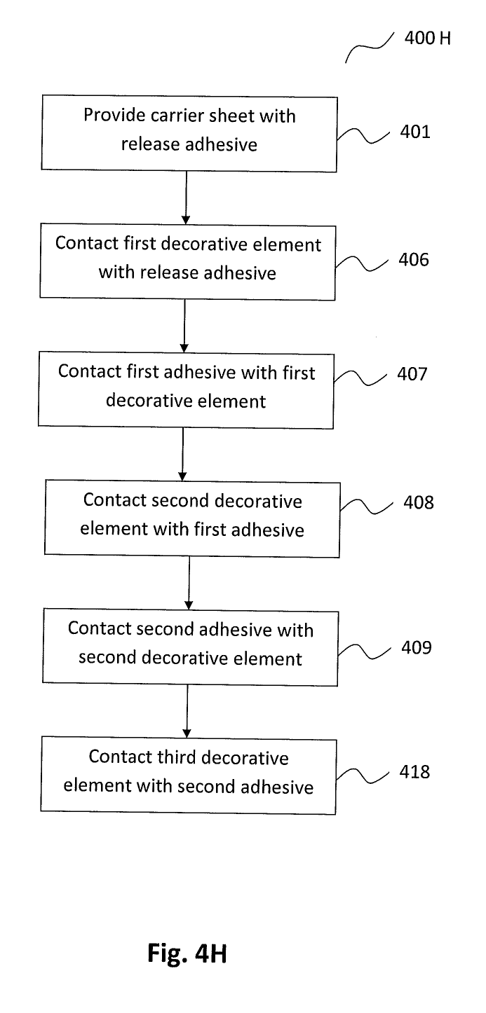

An exemplary process described above is shown in FIG. 4A. FIG. 4A depicts a process 400A for making the decorative article 300A (FIG. 3A). In step 401, a common carrier sheet 210 having a release adhesive 220 is provided. The common carrier sheet 210 has one or more carrier sheet registering marks (not depicted).

Generally, the process 400A includes in addition to step 401, steps 402 and 403. In step 402, one or more of the decorative elements 204, 204a, 204b, 204c, . . . and 204z are contacted with the release adhesive 220. Step 402 may be repeated until all of the decorative elements are contacted with the release adhesive 220. Generally, the decorative elements are provided on a transfer sheet having one or more transfer sheet registering marks. Typically, the one or more carrier sheet and the transfer sheet registering marks are registered with one another before and/or during the contacting of the one or more decorative elements with the release adhesive 220. In step 403, a first adhesive 225 is contacted with the decorative element first surface 204α. It can be appreciated that the decorative element second surface 204β is positioned on the release adhesive 220. Typically, the first adhesive 225 is provided on a transfer sheet having one or more transfer sheet registering marks. More typically, the one or more carrier sheet and the transfer sheet registering marks are registered with one another before and/or during the contacting of the first adhesive 225 with the decorative element first surface 204α.

In another example, a method can include providing a transfer sheet having two or more decorative elements adhered to a common carrier sheet by a release adhesive and adhering, by a first adhesive, an additional decorative element to one or more of the other decorative elements. Stated another way, the additional decorative element can be adhered to one or more other decorative elements by the first adhesive.

In a configuration having at least four decorative elements, two or more decorative elements may differ from the two or more other decorative elements in one or both of composition and texture. Furthermore, the additional decorative element(s) may differ from the other decorative elements in one or both of composition and texture.

Each of the decorative elements can have opposing first and second first decorative element surfaces. The first surfaces of two or more decorative elements can be in contact with the release adhesive. One or more of the second surfaces of the other decorative elements can be in contact with the first adhesive.

The method may further include one or both of: contacting the additional decorative element(s) with the first adhesive and applying one or both heat and pressure before, during, and after the contacting of the additional decorative element(s) with the first adhesive.

The method may further include one or more of: (a) contacting, prior to adhering the additional decorative element(s) to one or more of the other decorative elements, the first adhesive with one or more second surfaces of other decorative elements; (b) contacting, thereafter and/or during the contacting of first adhesive with the one or more of the second surfaces of the other decorative elements, the additional decorative element with the first adhesive; and (c) applying one or both of heat and pressure before, during, and/or after the contacting of the additional decorative element with the first adhesive.

The contacting of the first adhesive with one or more the second surfaces of the other decorative elements can further include one or more of: screen-printing the first adhesive on the second surfaces of the other decorative elements; contacting the first adhesive in the form of a self-supporting first adhesive film with the second surfaces of the other decorative elements; spraying the first adhesive on the second surfaces of the other decorative elements; depositing the first adhesive, in particulate form, on the second surfaces of the other decorative elements; or a combination thereof.

The method can further include: contacting, before the contacting of the additional decorative element with the first adhesive, the spacer with some (but less than most) or most, but not all, of the first adhesive.

The method can further include one or more of: providing the common carrier sheet having one or more registering elements and release adhesive; registering the two or more decorative elements with the one or more registering elements; contacting the two or more decorative elements in registration with the common carrier sheet; and adhering the two or more decorative elements to the common carrier sheet.

The method can further include, before adhering the additional decorative element to the other decorative element(s), one or both of: registering the additional decorative element with the one or more registering elements and contacting the additional decorative element with the first adhesive.

The other decorative elements can be selected from the group of decorative elements consisting of a metallized material, flock and a textile material. Moreover, the additional decorative element(s) can be selected from the group of decorative element(s) consisting of a metallized material, flock, and a textile material.

The additional decorative element(s) can be a metallized material. Furthermore, the two or more decorative elements can be selected from the group consisting textile materials, flocks and combinations thereof.

The additional decorative element(s) can be flock. Furthermore, the two or more decorative elements commonly can be selected from the group consisting of textile materials, polymeric materials, metallized materials, and combinations thereof. More commonly, the two or more decorative elements can be selected from the group consisting of textile materials and metallized materials, and combinations thereof.

The additional decorative element(s) can be a textile material. Moreover, the other decorative elements can be selected from the group consisting metallized materials, textile materials, and flock. Generally, when one or more of the other decorative elements and the additional decorative element(s) are textile materials, the additional decorative textile material(s) differs in one or both of composition and texture from the textile materials of the other decorative elements. More generally, when one or more of the other decorative elements and the additional decorative element(s) are textile materials, the textile materials of the other decorative elements differ in one or both of composition and texture from the additional decorative textile material.

The additional decorative element can have opposing first and second surfaces. The additional decorative element first surface can be in contact with the first adhesive. The method can further include: contacting a second adhesive with the additional decorative element(s) second surface.

The contacting of the second adhesive with the additional decorative element(s) second surface can further include one or more of: screen-printing the second adhesive on the additional decorative element second surface; contacting the first adhesive in the form of a self-supporting second adhesive film with the additional decorative element second surface; spraying the second adhesive on the additional decorative element second surface; depositing the second adhesive, in particulate form, on the additional decorative element second surface; or a combination thereof.

The method can further include: contacting the spacer with some (but less than most) or most, but not all, of the second adhesive.

The method can further include one or both of: contacting the second adhesive with a substrate and adhering the additional decorative element(s) and the other decorative elements to the substrate.

The method can further include one or both of: contacting the second adhesive with the substrate and adhering the additional decorative element(s) and the other decorative elements to the substrate.

In yet another example, the method can include providing a transfer sheet having the first decorative element adhered to a common carrier sheet by the release adhesive; adhering the second decorative element to the first decorative element; and adhering the third decorative element to the first decorative element. Two or more of the first, second and third decorative elements can differ by one or both of composition and texture.

The various decorative elements can have opposing first and second first decorative element surfaces. Moreover, the first decorative element first surface can be in contact with the release adhesive. Furthermore, the first decorative element second surface can be in contact with the first adhesive.

The method can further include one or more of: contacting the second decorative element with the first adhesive; contacting the third decorative element with the first adhesive; and applying one or both of heat and pressure one or more of before, during, and after the contacting of the first adhesive with the second and third decorative elements.

The method may further include one or more of: contacting, prior to adhering the second decorative element to the first decorative element, a second adhesive with the first decorative element second surface; applying one or both of heat and pressure before, during, and/or after the contacting of the first and second decorative elements with the second adhesive; contacting, prior to adhering the third decorative element to the first decorative element, a third adhesive with the first decorative element second surface; and applying one or both of heat and pressure before, during, and/or after the contacting of the first and third decorative elements with the third adhesive. The second and third adhesives can be substantially the same or different.

The method may further include: positioning, before the adhering of the first decorative element to the second decorative element, the spacer between some (but less than most) or most, but not all, of the first and second decorative elements.

The method may further include: positioning, before the adhering of the first decorative element to the third decorative element, the spacer between some (but less than most) or more, but not all, of the first and third decorative elements.

The method can further include one or more of: providing the common carrier sheet with one or more registering elements and a release adhesive; registering the first decorative element with the one or more registering elements; contacting, after registering the first decorative element, the first decorative element with the common carrier sheet; and adhering the first decorative element to the common carrier sheet.

The method may further include, before adhering the second and third decorative elements to the first decorative element, one or more of: registering the second decorative element with the one or more registering elements; contacting, after registering the second decorative element, the second decorative element with the first decorative element; registering the third decorative element with the one or more registering elements; and contacting, after registering the third decorative element, the third decorative element with the first decorative element.

The first, second, and third decorative elements can be selected from the group of decorative elements consisting of the metallized material, flock and textile material.

The first decorative element can be a metallized material, and the second and third decorative element can each be one of a textile material, a polymeric material in the form of a film, or a flock. When the second and third decorative elements are textile materials, the second decorative element textile material typically differs from the third decorative material textile material in one or both of composition and texture. When the second and third decorative elements are flock, the second and third decorative element flocks can be substantially the same. When the second and third decorative elements are flock, the second and third decorative element flocks can differ substantially.

The first decorative element can be flock. Furthermore, the second and third decorative elements can be one of a textile material, a polymeric material in the form of a film, or a metallized material. Typically, the second and third decorative element textile materials differ in one or both of composition and texture.

The first decorative element can be a textile material. The second and third decorative elements can be one of a metallized material, a textile material, a polymeric material in the form of a film, or flock. When one or more of the first, second and third decorative elements are textile materials, two or more of the first, second and third decorative element textile materials can differ in one or both of composition and texture. When the first and second decorative elements are textile materials, the first and second decorative element textile materials can differ in one or both of composition and texture. When the first and third decorative elements are textile materials, the first and third decorative element textile materials can differ in one or both of composition and texture. When the second and third decorative elements are textile materials, the second and third decorative element textile materials can differ in one or both of composition and texture. When the second and third decorative elements are flock, the second and third decorative element flocks can be substantially the same. When the second and third decorative elements are flock, the second and third decorative element flocks can differ substantially.

The second and third decorative elements can have opposing first and second surfaces. The first decorative element can be positioned adjacent the second decorative element first surface and the third decorative element first surface.

The method can further include: contacting the fourth adhesive with one or both of the second and third decorative element second surfaces.

The contacting of the fourth adhesive with the one or both of the second and third decorative element second surfaces can further include one or more of: screen-printing the fourth adhesive on the one or both of the second and third decorative element second surfaces; contacting the fourth adhesive in the form of a self-supporting second adhesive film with the one or both of the second and third decorative element second surfaces; spraying the fourth adhesive on the one or both of the second and third decorative element second surfaces; depositing the fourth adhesive, in particulate form, on the one or both of the second and third decorative element second surfaces; or a combination thereof.

The method can further include: contacting the spacer with some (but less than most) or most, but not all, of the fourth adhesive.

The method can further include one or more of: contacting the fourth adhesive with the substrate and adhering the first, second and third decorative elements to the substrate.

The method can further include one or both of: contacting the fourth adhesive with the substrate; and adhering the first, second and third decorative elements to the substrate.

In yet another example, the method can include providing a common carrier sheet having the release adhesive; contacting the first decorative element with the common carrier sheet; and contacting the second decorative element with the common sheet.

The first decorative element can be in contact with the first areal portion of the common carrier sheet. Furthermore, the second decorative element can be in contact with a second areal portion of the common carrier sheet. Commonly, the first and second decorative elements one or both: a) differ by one or both of composition and texture; and b) are in contact with the release adhesive.

The common carrier sheet can have one or more registering elements. The method can further include registering the first and second decorative elements with the common carrier sheet.

The first and second decorative elements can be one of the metallized material, textile material, or flock. Commonly the first decorative element differs from the second decorative element by one or more of composition, form and texture. When the first and second decorative elements are metallized materials, the first decorative element metallized material can differ from the second decorative element metallized material by one of composition, form and texture. When the first and second decorative elements are textile materials, the first decorative element textile material can differ from the second decorative element textile material by one of composition, form and texture. When the first and second decorative elements are flock, the first and second decorative element flocks can be substantially the same. When the first and second decorative elements are flock, the first and second decorative element flocks can differ substantially.

The first decorative element can be the metallized material and the second decorative element can be one of the textile material, polymeric material in the form of a film, or flock. The first decorative element can be the metallized material, and the second decorative element can be one of the textile material or flock.

The first decorative element can be the textile material, and the second decorative element can be one of the metallized material, a textile material having one or both of a different composition and texture than the first decorative element textile material, the polymeric material in the form of film, or flock.

The first decorative element can be flock, and the second decorative element can be one of the metallized material, the polymeric material in the form of film, or the textile material.

The contacting of the first decorative element with the carrier sheet can further include: adhering a first surface of the first decorative element to the carrier sheet. Typically, the contacting of the second decorative element with the carrier sheet can further include adhering a first surface of the second decorative element to the carrier sheet.

The method can further include contacting a first adhesive with one or both of the first and second decorative elements. According to the method, the first adhesive can be contacted with one or both of the second surface of the first decorative element and a second surface of the second decorative element.

The contacting of the first adhesive with one or both of first and second decorative elements can further include one or more of: screen-printing the first adhesive on one or both of first and second decorative elements; contacting the first adhesive in the form of a self-supporting first adhesive film with one or both of first and second decorative elements; spraying the first adhesive on one or both of first and second decorative elements; depositing the first adhesive, in particulate form, on one or both of first and second decorative elements; or a combination thereof.

The method can further include contacting the spacer with some (but less than most) or most, but not all, of the first adhesive.

The method can further include one or both of contacting the first adhesive with the substrate and adhering the adhering the first and second decorative elements to the substrate.

The method can further include one or both of contacting the first adhesive with the substrate and adhering the adhering the first and second decorative elements to the substrate.

The first, second, third, and fourth adhesives may be one of a thermosetting adhesive, a thermoplastic adhesive, a substantially A-staged thermosetting adhesive, a substantially B-staged thermosetting adhesive, a self-supporting adhesive film, a bi-laminate adhesive film having first and second adhesive layers, the first adhesive layer and second adhesive layer differing in one or both of chemical composition and physical properties, a tri-laminate adhesive film having a polymeric film positioned between a first adhesive film and a second adhesive film, a fast flow, low-melt adhesive, a hot-melt adhesive; and a combination and/or mixture thereof. Further regarding the tri-laminate adhesive film, the first adhesive film and second adhesive film may differ in one or both of chemical composition and physical properties, or have substantially the same chemical composition and physical properties and the polymeric film may comprise one or more of an elastomeric material, a substantially inelastic material, clear, opaque, colored, uncolored, or a combination thereof. The polymeric film may be a tie layer.

Various examples of methods will now be discussed to illustrate the above-discussed features.

One exemplary process is shown in FIG. 4B. FIG. 4B depicts a process 400B for making the decorative article 300B (FIG. 3B). Generally, the process 400B includes in addition to step 401, steps 404 and 405. In step 405, a first adhesive 225 is contacted with the release adhesive 220. Typically, the first adhesive 225 is provided on a transfer sheet having one or more transfer sheet registering marks. More typically, the one or more carrier sheet and the transfer sheet registering marks are registered with one another before and/or during the contacting of the first adhesive 225 with the release adhesive 220. In step 405, one or more of the decorative element 204, 204a, 204b, 204c, . . . and 204z are contacted with the first adhesive 225. Step 405 may be repeated until all of the decorative elements are contacted with the first adhesive 225. Generally, the decorative elements are provided on a transfer sheet having one or more transfer sheet registering marks. Typically, the one or more carrier sheet and the transfer sheet registering marks are registered with one another before and/or during the contacting of the one or more decorative elements with the first adhesive 225.

FIGS. 4C-4F depict exemplary processes described above to manufacture decorative articles 300C-300F, respectively.

Referring to FIG. 4C in step 401, a common carrier sheet 210 having a release adhesive 220 is provided. The common carrier sheet 210 has one or more carrier sheet registering marks (not depicted).

In step 406, the first decorative element 201 is contacted with the release adhesive 220. Generally, the first decorative element is provided on a transfer sheet having one or more transfer sheet registering marks. Typically, the one or more carrier sheet and the transfer sheet registering marks are registered with one another before and/or during the contacting of the first decorative element with the release adhesive 220. In step 406, a first decorative element second surface 201β is contacted the release adhesive 220. It can be appreciated that the decorative element second surface 204β is positioned on the release adhesive 220.

In step 407, the first adhesive 225 is contacted with the first decorative element 201. Typically, the first adhesive 225 is provided on a transfer sheet having one or more transfer sheet registering marks. More typically, the one or more carrier sheet and the transfer sheet registering marks are registered with one another before and/or during the contacting of the first adhesive 225 with the first decorative element 201. Even more typically, the first adhesive 225 is contacted with the first decorative element first surface 201α. Commonly, step 407 may further include contacting one of the first adhesive 225 or the first decorative element first surface 201α with one or both of a spacer and/or polymeric material in the form of a film 240.

In step 408, the second decorative element 202 is contracted with the first adhesive 225. Typically, the second decorative element 202 is provided on a transfer sheet having one or more transfer sheet registering marks. More typically, the one or more carrier sheet and the transfer sheet registering marks are registered with one another before and/or during the contacting of the second decorative element 202 with the first adhesive 225. Even more typically, the second decorative element second surface 202β is contacted with the first adhesive 225.

In optional step 409, the second adhesive 226 is contacted with the second decorative element 202. Typically, the second adhesive 226 is provided on a transfer sheet having one or more transfer sheet registering marks. More typically, the one or more carrier sheet and the transfer sheet registering marks are registered with one another before and/or during the contacting of the second adhesive 226 with the second decorative element 202. Even more typically, the second adhesive 226 is contacted with the second decorative element first surface 202α.

Generally, the process may further include (not depicted in process 400C) contacting the second adhesive 226 with one or both of a spacer and/or polymeric material in the form of a film 240. More generally, a substrate may be contacted with the second adhesive 226 (not depicted in process 400C).

FIG. 4D depicts a process 400D for making article 300D. In step 401, a common carrier sheet 210 having a release adhesive 220 is provided. The common carrier sheet 210 has one or more carrier sheet registering marks (not depicted).

In step 410, the second adhesive 226 is contacted with the release adhesive 220. Generally, the second adhesive 226 is provided on a transfer sheet having one or more transfer sheet registering marks. Typically, the one or more carrier sheet and the transfer sheet registering marks are registered with one another before and/or during the contacting of the second adhesive 226 with the release adhesive 220.

In step 411, the second decorative element 202 is contacted with the second adhesive 226. Typically, the second decorative element second surface 202β is contacted with the second adhesive 226. Typically, the second decorative element 202 is provided on a transfer sheet having one or more transfer sheet registering marks. More typically, the one or more carrier sheet and the transfer sheet registering marks are registered with one another before and/or during the contacting of the second decorative element 202 with the second adhesive 226.

Generally, the process may further include (not depicted in process 400D) contacting the second adhesive 226 with one or both of a spacer and polymeric material in the form of a film 240. The contacting of the one or both of the spacer and polymeric material in the form of a film 240 may be included in steps 410 and/or 411.

In step 412, the first adhesive 225 is contacted with the second decorative element 202. Typically, the first adhesive 225 is contacted with the second decorative element first surface 202α. Typically, the first adhesive 225 is provided on a transfer sheet having one or more transfer sheet registering marks. More typically, the one or more carrier sheet and the transfer sheet registering marks are registered with one another before and/or during the contacting of the first adhesive 225 with the second decorative element 202. Commonly, step 412 may further include contacting one of the first adhesive 225 or the second decorative element first surface 202α with one or both of a spacer and/or polymeric material in the form of a film 240.

In step 413, the first decorative element 201 is contacted with the first adhesive 225. Even more typically, the first decorative element second surface 201β is contacted with the first adhesive 225. Typically, the first decorative element 201 is provided on a transfer sheet having one or more transfer sheet registering marks. More typically, the one or more carrier sheet and the transfer sheet registering marks are registered with one another before and/or during the contacting of the first decorative element 201 with the first adhesive 225. Commonly, step 413 may further include contacting the first adhesive 225 with one or both of a spacer and/or polymeric material in the form of a film 240.

FIG. 4E depicts a process 400E for making article 300E. In step 401, a common carrier sheet 210 having a release adhesive 220 is provided. The common carrier sheet 210 has one or more carrier sheet registering marks (not depicted).

In step 414, the two or more decorative elements 204 are contacted with the release adhesive 220. Generally, the two or more decorative elements 204 are provided on a transfer sheet having one or more transfer sheet registering marks. Typically, the one or more carrier sheet and the transfer sheet registering marks are registered with one another before and/or during the contacting of the two or more decorative elements 204 with the release adhesive 220.

Moreover, step 414 may further include contacting one or more of the decorative elements 204a, 204b, 204c, . . . and 204z with the release adhesive 220. Further, step 414 may be repeated until all of the decorative elements are contacted with the release adhesive 220. Typically, the one or more decorative elements 204a, 204b, 204c, . . . and 204z are provided on a transfer sheet having one or more transfer sheet registering marks. Typically, the one or more carrier sheet and the transfer sheet registering marks are registered with one another before and/or during the contacting of the one or more decorative elements 204a, 204b, 204c, . . . and 204z with the release adhesive 220.

In step 415, the first adhesive 225 is contacted with the two or more decorative elements 204. Typically, the first adhesive 225 is provided on a transfer sheet having one or more transfer sheet registering marks. More typically, the one or more carrier sheet and the transfer sheet registering marks are registered with one another before and/or during the contacting of the first adhesive 225 with the one or more decorative elements 204. Even more typically, the first adhesive 225 is contacted with the two or more decorative elements first surface 204α. Commonly, step 415 may further include contacting one of the first adhesive 225 or the two or more decorative elements first surface 204α with one or both of the spacer and/or polymeric material in the form of a film 240.

In step 413, the first decorative element 201 is contacted with the first adhesive 225. Even more typically, the first decorative element second surface 201β is contacted with the first adhesive 225. Typically, the first decorative element 201 is provided on a transfer sheet having one or more transfer sheet registering marks. More typically, the one or more carrier sheet and the transfer sheet registering marks are registered with one another before and/or during the contacting of the first decorative element 201 with the first adhesive 225. Commonly, step 413 may further include contacting the first adhesive 225 with one or both of a spacer and/or polymeric material in the form of a film 240.

Generally, the process (not depicted in process 400E) may further include contacting the first decorative element first surface 201α with a second adhesive 226. Typically, the process may further include (not depicted in process 400E) contacting the second adhesive 226 with one or both of the spacer and/or polymeric material in the form of a film 240. More typically, a substrate may be contacted with the second adhesive 226 (not depicted in process 400C).

FIG. 4F depicts a process 400F for making article 300F. In step 401, a common carrier sheet 210 having a release adhesive 220 is provided. The common carrier sheet 210 has one or more carrier sheet registering marks (not depicted).

In step 410, the second adhesive 226 is contacted with the release adhesive 220. Generally, the second adhesive 226 is provided on a transfer sheet having one or more transfer sheet registering marks. Typically, the one or more carrier sheet and the transfer sheet registering marks are registered with one another before and/or during the contacting of the second adhesive 226 with the release adhesive 220.

In step 416, the first decorative element 201 is contacted with the second adhesive 226. Even more typically, the first decorative element second surface 201β is contacted with the second adhesive 226. Typically, the first decorative element 201 is provided on a transfer sheet having one or more transfer sheet registering marks. More typically, the one or more carrier sheet and the transfer sheet registering marks are registered with one another before and/or during the contacting of the first decorative element 201 with the second adhesive 226. Commonly, step 413 may further include contacting the second adhesive 226 with one or both of the spacer and/or polymeric material in the form of a film 240.

In step 407, the first adhesive 225 is contacted with the first decorative element 201. Typically, the first adhesive 225 is provided on a transfer sheet having one or more transfer sheet registering marks. More typically, the one or more carrier sheet and the transfer sheet registering marks are registered with one another before and/or during the contacting of the first adhesive 225 with the first decorative element 201. Even more typically, the first adhesive 225 is contacted with the first decorative element first surface 201α. Commonly, step 407 may further include contacting one of the first adhesive 225 or the first decorative element first surface 201α with one or both of a spacer and/or polymeric material in the form of a film 240.

In step 417, the two or more decorative elements 204 are contacted with the first adhesive 225. Generally, the two or more decorative elements 204 are provided on a transfer sheet having one or more transfer sheet registering marks. Typically, the one or more carrier sheet and the transfer sheet registering marks are registered with one another before and/or during the contacting of the two or more decorative elements 204 with the first adhesive 225. More generally, the two or more decorative elements second surface 204β is contacted with the first adhesive.

Moreover, step 417 may further include contacting one or more of the decorative elements 204a, 204b, 204c, . . . and 204z with the second adhesive 226. Further, step 417 may be repeated until all of the decorative elements are contacted with the second adhesive 226. Typically, the one or more decorative elements 204a, 204b, 204c, . . . and 204z are provided on a transfer sheet having one or more transfer sheet registering marks. Typically, the one or more carrier sheet and the transfer sheet registering marks are registered with one another before and/or during the contacting of the one or more decorative elements 204a, 204b, 204c, . . . and 204z with the first adhesive 225.

It can be appreciated that in methods 400C-D, decorative elements 201 and 202 can be interchanged, that is decorative element 201 positioned between release adhesive 220 and the first adhesive 225 can be replaced with decorative element 202 in any one or more steps comprising the respective methods. Similarly, decorative element 202 can be replaced with decorative element 201. It can be further appreciated that decorative element 202 may or may not have one or more apertures 298. Similarly, in methods 400E and 400F, decorative elements 201 and 204 can be interchanged, that is decorative element 201 may be substituted for decorative element 204 and decorative element 204 may be substituted form decorative element 201 in any of the respective steps. It can be further appreciated that decorative element 201 may or may not have one or more apertures 298. It be further appreciated that decorative element 204 may or may not have apertures 298.

FIGS. 4G and 4H depict processes 400G and 400H for, respectively, making articles 300G and 300G. The methods 400G and 400H (discussed below in connection with FIGS. 4G and 4H) comprise a decorative element 201 (or alternatively 202 or 204) adhered to second decorative element 202 (or alternatively 201 or 204) by a first adhesive 225, and a third decorative element 204 (or alternatively 201 or 202) may adhered to the second decorative element 202 (or alternatively 201 or 204) by a second adhesive 226. The first, second and third decorative elements may separately and independently be selected from the group of decorative elements consisting of a metallized material, textile material, polymeric material in the form of a film or flock. The metallized material, textile material, polymeric material in the form of a film and/or flock may be any of the respective materials described herein.

FIG. 4G depicts a process 400G for making article 300G. In step 401, a common carrier sheet 210 having a release adhesive 220 is provided. The common carrier sheet 210 has one or more carrier sheet registering marks (not depicted).

In step 410, the second adhesive 226 is contacted with the release adhesive 220. Generally, the second adhesive 226 is provided on a transfer sheet having one or more transfer sheet registering marks. Typically, the one or more carrier sheet and the transfer sheet registering marks are registered with one another before and/or during the contacting of the second adhesive 226 with the release adhesive 220.

In step 411, the second decorative element 202 (or one of 201 or 204) is contacted with the second adhesive 226. Typically, the second decorative element second surface 202β is contacted with the second adhesive 226. Typically, the second decorative element 202 is provided on a transfer sheet having one or more transfer sheet registering marks. More typically, the one or more carrier sheet and the transfer sheet registering marks are registered with one another before and/or during the contacting of the second decorative element 202 with the second adhesive 226.

Generally, the process may further include (not depicted in process 400D) contacting the second adhesive 226 with one or both of a spacer and polymeric material in the form of a film 240. The contacting of the one or both of the spacer and polymeric material in the form of a film 240 may be included in steps 410 and/or 411.

In step 412, the first adhesive 225 is contacted with the second decorative element 202. Typically, the first adhesive 225 is contacted with the second decorative element first surface 202α. Typically, the first adhesive 225 is provided on a transfer sheet having one or more transfer sheet registering marks. More typically, the one or more carrier sheet and the transfer sheet registering marks are registered with one another before and/or during the contacting of the first adhesive 225 with the second decorative element 202. Commonly, step 412 may further include contacting one of the first adhesive 225 or the second decorative element second surface 202α with one or both of a spacer and/or polymeric material in the form of a film 240.

In step 413, the first decorative element 201 is contacted with the first adhesive 225. Even more typically, the first decorative element second surface 201β is contacted with the first adhesive 225. Typically, the first decorative element 201 is provided on a transfer sheet having one or more transfer sheet registering marks. More typically, the one or more carrier sheet and the transfer sheet registering marks are registered with one another before and/or during the contacting of the first decorative element 201 with the first adhesive 225. Commonly, step 413 may further include contacting the first adhesive 225 with one or both of a spacer and/or polymeric material in the form of a film 240.

In step 419, a third adhesive 227 is contacted with the first decorative element. Typically, the third adhesive 227 is contacted with the first decorative element first surface 201α. Typically, the third adhesive 227 is provided on a transfer sheet having one or more transfer sheet registering marks. More typically, the one or more carrier sheet and the transfer sheet registering marks are registered with one another before and/or during the contacting of the third adhesive 227 with the first decorative element 201. Commonly, step 419 may further include contacting one of the third adhesive 227 or the first decorative element first surface 202α with one or both of a spacer and/or polymeric material in the form of a film 240.

In step 420, a third decorative 204 (or one of 201 or 202) is contacted with the third adhesive 227. Typically, the third decorative element second surface 204β is contacted with the third adhesive 227. Typically, the third decorative element 204 is provided on a transfer sheet having one or more transfer sheet registering marks. More typically, the one or more carrier sheet and the transfer sheet registering marks are registered with one another before and/or during the contacting of the third decorative element 204 with the third adhesive 227.

Referring to FIG. 4H in step 401, a common carrier sheet 210 having a release adhesive 220 is provided. The common carrier sheet 210 has one or more carrier sheet registering marks (not depicted).

In step 406, the first decorative element 201 (or one of 202 or 204) is contacted with the release adhesive 220. Generally, the first decorative element is provided on a transfer sheet having one or more transfer sheet registering marks. Typically, the one or more carrier sheet and the transfer sheet registering marks are registered with one another before and/or during the contacting of the first decorative element with the release adhesive 220. In step 406, a first decorative element second surface 201β is contacted the release adhesive 220. It can be appreciated that the decorative element second surface 204β is positioned on the release adhesive 220.

In step 407, the first adhesive 225 is contacted with the first decorative element 201. Typically, the first adhesive 225 is provided on a transfer sheet having one or more transfer sheet registering marks. More typically, the one or more carrier sheet and the transfer sheet registering marks are registered with one another before and/or during the contacting of the first adhesive 225 with the first decorative element 201. Even more typically, the first adhesive 225 is contacted with the first decorative element first surface 201α. Commonly, step 407 may further include contacting one of the first adhesive 225 or the first decorative element first surface 201α with one or both of a spacer and/or polymeric material in the form of a film 240.

In step 408, the second decorative element 202 (or one of 201 or 204) is contracted with the first adhesive 225. Typically, the second decorative element 202 is provided on a transfer sheet having one or more transfer sheet registering marks. More typically, the one or more carrier sheet and the transfer sheet registering marks are registered with one another before and/or during the contacting of the second decorative element 202 with the first adhesive 225. Even more typically, the second decorative element second surface 202β is contacted with the first adhesive 225.

In step 409, the second adhesive 226 is contacted with the second decorative element 202. Typically, the second adhesive 226 is provided on a transfer sheet having one or more transfer sheet registering marks. More typically, the one or more carrier sheet and the transfer sheet registering marks are registered with one another before and/or during the contacting of the second adhesive 226 with the second decorative element 202. Even more typically, the second adhesive 226 is contacted with the second decorative element first surface 202α.

In step 418, the third decorative element 204 (or one of 201 or 202) is contracted with the second adhesive 226. Typically, the third decorative element 204 is provided on a transfer sheet having one or more transfer sheet registering marks. More typically, the one or more carrier sheet and the transfer sheet registering marks are registered with one another before and/or during the contacting of the third decorative element 204 with the second adhesive 226. Even more typically, the third decorative element second surface 204β is contacted with the second adhesive 226.

Generally, the method may further include (not depicted in process 400H) contacting the third decorative element with a third adhesive. The third adhesive is typically contacted with the third decorative element first surface 204α. Generally, the process may further include (not depicted in process 400C) contacting the third adhesive 227 with one or both of a spacer and/or polymeric material in the form of a film 240. More generally, a substrate may be contacted with the third adhesive 227 (not depicted in process 400H).

Further regarding the methods, any one or more of the first, second and third decorative elements can be provided with one or more adhesives. More specifically, the adhesives may in contact one or both of opposing first and second surfaces. For example, any one or more of the first, second and third decorative elements can be provided with one or more of the first, second, third or fourth adhesives in contact with the first surface of the respective decorative element. Further by way of example, any one or more of the first, second and third decorative elements can be provided with one or more of the first, second, third or fourth adhesives in contact with the second surface of the respective decorative element.

Further regarding the articles and methods disclosed herein, one or more of the first, second, third and fourth adhesives can be an elastic adhesive powder. The elastic adhesive powder can be printed, such as screen printed on the decorative element (that is, any one of first, second, third and fourth decorative elements). Typically, the elastic adhesive powder is printed on the decorative element as a fine adhesive line, more typically as two or more lines. The fine adhesive lines stretch and recover well. That is, the fine adhesive lines can be stretched two times their length and return to less than about 1.1 times their pre-stretched length. More specifically, the fine adhesive lines can be stretched from about two to about 10 times their length and return to less than about 1.1 times their pre-stretched length. Moreover, most of the fine adhesive lines remain substantially intact, that is do not split, when stretched to about two times their length, generally ten times their length. The fine adhesive line having an adhesive line width of no more 10 mm. The two or more fine lines can be separated by an adhesive void or other discontinuity. The adhesive void or other discontinuity commonly separates two nearest neighbor fine adhesive lines by no more than about 2 adhesive line widths, more commonly by no more than about 6 adhesive line widths, even more commonly by no more than about 9 adhesive line widths, yet even more commonly by no more than about 15 adhesive line widths, yet even more commonly by no more than about 20 adhesive line widths, yet even more commonly by no more than about 25 adhesive line widths, yet even more commonly by no more than about 30 adhesive line widths, yet even more commonly by no more than about 35 adhesive line widths, yet even more commonly by no more than about 40 adhesive line widths, yet even more commonly by no more than about 45 adhesive line widths, or even yet more commonly by no more than about 50 adhesive line widths. In some instances the adhesive void or other discontinuity can separate the two nearest neighbor fine adhesive lines by no more than about 50 adhesive line widths.

Further regarding the articles and methods disclosed herein, one of the decorative articles can have one or more voids, the other of the decorative articles can be provided with variable information to be positioned in the voids. While not wanting to be limited by example, the decorative article may be badge. More specifically, the metalized decorative article can be a badge. The voids can be voids where a name, rank, title, or other variable information is typically provided on the badge. The other decorative elements can be one or more of a metalized, polymeric material in the form of a film, textile or flock decorative material containing the variable information can be positioned and/or displayed in the void.

Further regarding the articles and methods disclosed herein, one or more of the decorative elements described herein can be a polymeric film material. The polymeric film material can be a smooth plastic film. The polymeric film material may comprise one of an embossed polymeric film, a pre-textured polymeric film, a hologram-containing polymeric film, a lenticular polymeric film, a polymeric film having series of aperture or other discontinuities, or combination thereof. Commonly, one or more, but not all, of the decorative elements described herein (such as, the first, second, third and such decorative elements) can be the polymeric film material. More commonly, any one of the decorative elements described herein may comprise the polymeric film material. The polymeric film material generally comprises polyurethane. The polymeric film material can have any hue. The hue may be white, black, or any hue other than white or black. The hue may have any level of saturation. The polymeric film material may contain an image. The image may be a printed image. The image may comprise a screen-printed and/or sublimation dye image. It can be appreciated that, if the polymeric film is sublimation dye printed, the polymeric film is substantially heat resistant, that is substantially thermally stable, at the sublimation dye printing temperature. Laser etching and/or ablating the polymeric film material can form the image. The polymeric film material can have two or more layers. While not wanting to be bound by example, the polymeric film material may comprise a pigment-containing polymeric layer and an adhesive layer. The adhesive layer can be any of the adhesives disclosed herein. The adhesive layer may be contacted with (in any of the in any of herein disclosed methods) and/or in contact with (in any of the herein disclosed articles) a substrate (as disclosed herein) or any of the decorative elements (as disclosed herein). The polymeric film may or may not elastomeric. The polymeric film may have substantially the same metallic hue and/or value as the metallized material.

It can be appreciated that above articles and methods of making the articles combine decorative elements to create and enhance the dimensional aspects of the article. For example, textile materials having contrasting yarns, contrasting surfaces (such as from knitting or weaving process) can be combined to create a more dimensional and/or compelling article. Furthermore, the textile material yarn and/or textile surface can create a more dimensional and/or compelling article when combined with flock and/or metallized materials.

The decorative article 100 can be formed into a three-dimensional design using a high frequency die (such as an RF or Radio Frequency) die to generate heat. The heat softens the laminate and adhesive and forms the film into a three-dimensional molded shape that is the positive image of the negative image in the mold. The die includes cut edges that cut the laminate into a desired exterior perimeter shape. These steps may be performed in the absence or presence of the adhesive and substrate.

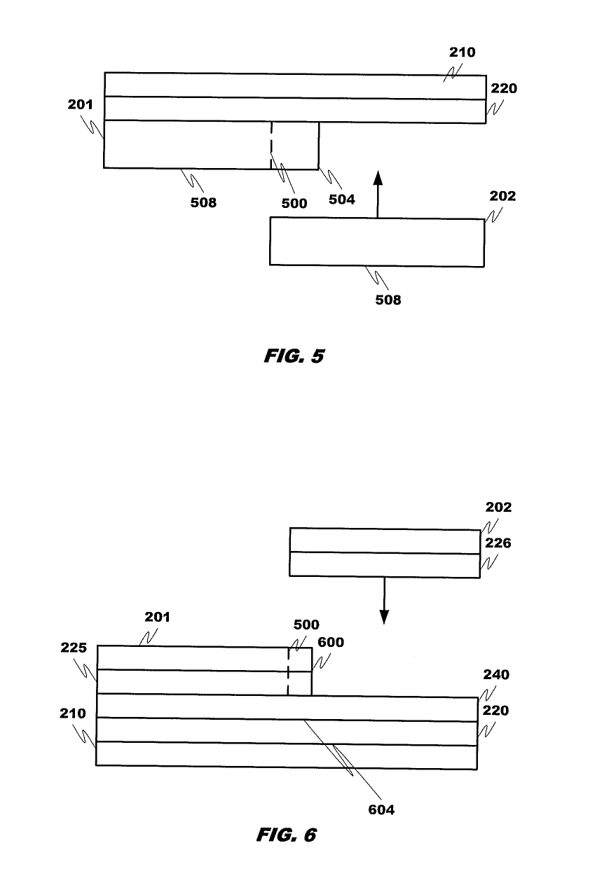

Laser cutting may be used in any of the above methods to cut to correct size and shape decorative elements. FIGS. 5 and 6 illustrate this technique. With reference to FIG. 5, an intermediate decorative article product is depicted. The intermediate product includes a carrier sheet 210, release adhesive 220, and first decorative element 225. A second decorative element 202 is ready to be positioned on the release adhesive 220 adjacent to the first decorative element 201. To make that possible, a laser cuts the first decorative element 201 along cut line 500. The unwanted part 504 of the first decorative element 201 is removed from the release adhesive 220 and the second decorative element 202 positioned in its place. A second adhesive (not shown) can then be applied to the substantially planar free surface 508 defined by the first and second decorative elements 201 and 202 to provide the decorative article. With reference to FIG. 6, another intermediate decorative article product is depicted. The intermediate product includes a carrier sheet 210, release adhesive 220, first decorative element 225, first adhesive 225, and tie material 240. The first adhesive 225 adheres the first decorative element 225 to the tie material 240. A second decorative element 202 and second adhesive 226 are ready to be positioned and adhered to the tie material 240 adjacent to the first decorative element 201. To make that possible, a laser cuts the first decorative element 201 and first adhesive 225 along cut line 500. The unwanted part 600 of the first decorative element 201 and first adhesive 225 are removed from the tie material 240 and the second decorative element 202 and second adhesive 226 positioned in its place and adhered, such as by heat lamination or sealing, to the tie material 240. A third adhesive (not shown) can then (optionally) be applied to the substantially planar free surface 604 defined by the tie material 220 (after removal of the release adhesive 220 and carrier sheet 210) to provide the decorative article.

A number of variations and modifications of the disclosure can be used. It would be possible to provide for some features of the disclosure without providing others.

For example in one alternative embodiment, the first, second, and third decorative elements are the same type of material, namely one of metallized, textile, and flock materials, but have differing mechanical and/or surface properties and/or compositions. The above article configurations and processes apply to this alternative embodiment.

In another alternative embodiment, the decorative articles can be molded, by a suitable technique, to form a molded article containing the decorative article. The decorative can be placed in a mold, contacted with a polymer resin, and, when the polymer resin solidifies, the molded article is removed from the mold.

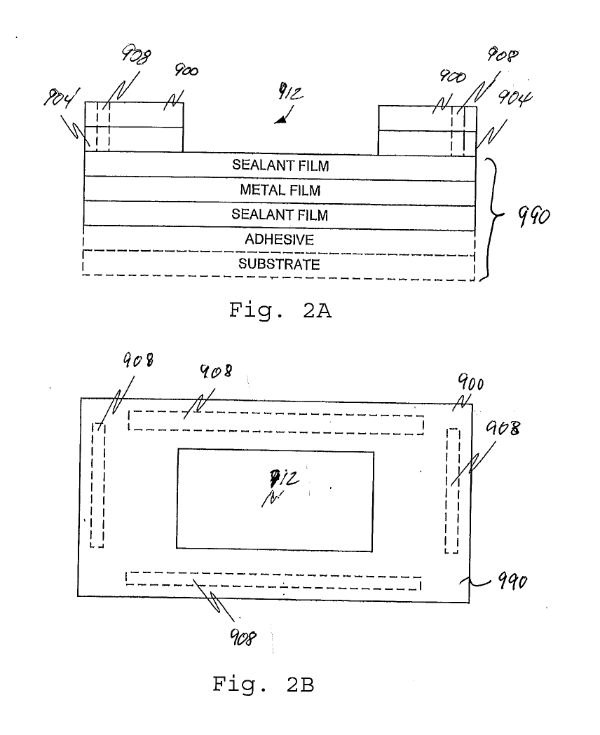

With reference to FIGS. 2A and 2B, an intermediate assembly includes a decorative element 900, and an adhesive 904 adhered to the decorative article 990.

The decorative element 900 can be a fiber, such as flock, or a woven, unwoven, or knitted material. The adhesive 904 can be any of the adhesive materials disclosed herein.

Because the decorative element 900 is typically a polyester or nylon or other high melting point material, the high frequency RF die used to cut and mold or shape the decorative element 900 is unable to cut through the decorative element 200.

To overcome this limitation, gaps, voids, or spaces 908 are used to enable the high frequency radio frequency energy to contact the decorative article 990 to cut the exterior shape of the final design. A window 912 enables a viewer to view the decorative article 990 (which is being used as an insert). The gaps, voids, or spaces 908 in the decorative element 900 are collocated with desired cut lines and enable the molding die to move past the decorative element 900 to cut or remove selectively the decorative article 990 only. The inner portions of the window in the window 912 are also in contact with the radio frequency energy and/or the die itself and therefore can be formed into the desired three-dimensional, geometric shape. In both the exterior and interior areas, the decorative article 990 will be soften from the reaction with the high frequency energy. Typically, the molding of the decorative article 990 will not be constrained by the decorative element 900 or adhesive layer 904, particularly when one or both of the decorative element 900 and adhesive 904 have elastic properties. In fact, the softening of the decorative article 990 will occur substantially throughout the areal extent of the decorative article 990, thereby enabling a three dimensional feature to be formed not only in the window 912 but also beneath the decorative and adhesive 904 and decorative element 900.

The present disclosure, in various aspects, embodiments, and configurations, includes components, methods, processes, systems and/or apparatus substantially as depicted and described herein, including various aspects, embodiments, configurations, subcombinations, and subsets thereof. Those of skill in the art will understand how to make and use the various aspects, aspects, embodiments, and configurations, after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more, aspects, embodiments, and configurations for the purpose of streamlining the disclosure. The features of the aspects, embodiments, and configurations of the disclosure may be combined in alternate aspects, embodiments, and configurations other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed aspects, embodiments, and configurations. Thus, the following claims are hereby incorporated into this Detailed Description, with each claim standing on its own as a separate preferred embodiment of the disclosure.

Moreover, though the description of the disclosure has included description of one or more aspects, embodiments, or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
providing a common carrier sheet having an adhesive;
contacting a first decorative element with the common carrier sheet; and
contacting a second decorative element with the common sheet, wherein the first decorative element is in contact with a first areal portion of the common carrier sheet, wherein the second decorative element is in contact with a second areal portion of the common carrier sheet, and wherein the first and second decorative elements:
a) differ by one or both of composition and texture; and
b) are in contact with the release adhesive.

2. A method, comprising:
providing a transfer sheet having a first decorative element adhered to a common carrier sheet by an adhesive; and
adhering a second decorative element to the first decorative element, wherein the first and second decorative elements differ by one or both of composition and texture and wherein the second decorative element is adhered to first decorative element by a first adhesive.

3. A method, comprising:
providing a transfer sheet having two or more decorative elements adhered to a common carrier sheet by a release adhesive; and
adhering an additional decorative element to one or more of the two or more decorative elements, and wherein the additional decorative element is adhered to the one or more of the two or more decorative elements by a first adhesive.

4. A method, comprising:
providing a transfer sheet having a first decorative element adhered to a common carrier sheet by an adhesive;
adhering a second decorative element to the first decorative element; and
adhering a third decorative element to the first decorative element, wherein the two or more of the first, second and third decorative elements differ by one or both of composition and texture.

5. The method of claim 4, wherein the first decorative element has opposing first and second first decorative element surfaces, wherein the first decorative element first surface is in contact with the release adhesive and wherein the first decorative element second surface comprises a first adhesive, the method further comprising:
contacting the second decorative element with the first adhesive;
contacting the third decorative element with the first adhesive; and
applying one or both heat and pressure one or more of before, during, and after the contacting of the first adhesive with the second and third decorative elements.

6. The method of claim 5, wherein the first adhesive comprises one or more of:
a thermosetting adhesive;
a thermoplastic adhesive;
a substantially A-staged thermosetting adhesive;
a substantially B-staged thermosetting adhesive;
a self-supporting adhesive film;
a bi-laminate adhesive film having first and second adhesive layers, the first adhesive layer and second adhesive layer differ in one or both of chemical composition and physical properties;
a tri-laminate adhesive film having a polymeric film positioned between a first adhesive film and a second adhesive film, wherein the first adhesive film and second adhesive film may:
i) differ in one or both of chemical composition and physical properties, or
ii) have substantially the same chemical composition and physical properties, and
wherein the polymeric film may comprise one or more of:
iii) an elastomeric material;
iv) a substantially inelastic material;
v) clear, opaque, colored, uncolored;
vi) a combination thereof; or
a fast flow, low-melt adhesive;
a hot-melt adhesive;
a combination and/or mixture thereof.

7. The method of claim 4, wherein the first decorative element has opposing first and second decorative element surfaces, wherein the first decorative element first surface is in contact with the release adhesive, the method further comprising:
contacting, prior to adhering the second decorative element to the first decorative element, a second adhesive with the first decorative element second surface;
applying one or both of heat and pressure before, during, and/or after the contacting of the first and second decorative elements with the second adhesive;
contacting, prior to adhering the third decorative element to the first decorative element, a third adhesive with the first decorative element second surface; and
applying one or both of heat and pressure before, during, and/or after the contacting of the first and third decorative elements with the third adhesive, wherein the second and third adhesives are one of substantially the same or different.

8. The method of claim 7, wherein the second and third adhesives independently comprise one or more of:
a thermosetting adhesive;
a thermoplastic adhesive;
a substantially A-staged thermosetting adhesive;
a substantially B-staged thermosetting adhesive;
a self-supporting adhesive film;
a bi-laminate adhesive film having first and second adhesive layers, the first adhesive layer and second adhesive layer differ in one or both of chemical composition and physical properties;
a tri-laminate adhesive film having a polymeric film positioned between a first adhesive film and a second adhesive film, wherein the first adhesive film and second adhesive film may:
i) differ in one or both of chemical composition and physical properties, or
ii) have substantially the same chemical composition and physical properties, and
wherein the polymeric film may comprise one or more of:
iii) an elastomeric material;
iv) a substantially inelastic material;
v) clear, opaque, colored, uncolored;
vi) a combination thereof; or
a fast flow, low-melt adhesive;
a hot-melt adhesive;
a combination and/or mixture thereof.

9. The method of claim 4, further comprising:
positioning, before the adhering of the first decorative element to the second decorative element, a spacer between some, but not all, of the first and second decorative elements.

10. The method of claim 4, further comprising:
positioning, before the adhering of the first decorative element to the third decorative element, a spacer between some, but not all, of the first and third decorative elements.

11. The method of claim 4, wherein the transfer sheet has one or more registering elements.

12. The method claim 11, wherein the providing of the transfer sheet further comprises:
providing the common carrier sheet with the one or more registering elements and release adhesive;
registering the first decorative element with the one or more registering elements; and
contacting, after registering the first decorative element, the first decorative element with the common carrier sheet; and
adhering the first decorative element to the common carrier sheet.

13. The method of claim 11, the method further comprising, before adhering the second and third decorative elements to the first decorative element:
registering the second decorative element with the one or more registering elements;
contacting, after registering the second decorative element, the second decorative element with the first decorative element;
registering the third decorative element with the one or more registering elements; and
contacting, after registering the third decorative element, the third decorative element with the first decorative element.

14. The method of claim 4, wherein the first decorative element is selected from the group of decorative elements consisting of a metallized material, a flock and a textile material, wherein the second decorative element is selected from the group of decorative element consisting of a metallized material, flock, and a textile material, and wherein the third decorative element is selected from the group consisting of a metallized material, flock, and a textile material.

15. The method of claim 14, wherein the metallized material is one of:
a polymeric composition-containing metallized particles;
a polymeric composition having a metallized coating;
a polymeric composition having a metallized appearance;
a metal-containing composition; and
a combination and/or mixture thereof.

16. The method of claim 14, wherein the textile material is one of:
a woven textile material;
a knitted textile material;
a non-woven, non-knitted textile material;
a substantially elastomeric textile material;
a substantially non-elastomeric textile material; and
a combination and/or mixture thereof.

17. The method of claim 4, wherein the first decorative element comprises a metallized material, wherein the second decorative element comprises one of a second decorative element textile material or a second decorative element flock, wherein the third decorative element comprises one of a third decorative element textile material or a third decorative element flock, wherein the second and third decorative element textile materials differing in one or both of composition and texture, and wherein the second and third decorative element flocks are the same or differ.

18. The method of claim 4, wherein the first decorative element comprises a first decorative element flock, wherein the second decorative element comprises one of a second decorative element textile material, or a second decorative element metallized material, wherein the third decorative element comprises one of a third decorative element textile material, or a third decorative element metallized material, wherein second and third decorative element textile materials differ in one or both of composition and texture.

19. The method of claim 4, wherein the first decorative element comprises a first decorative element textile material, wherein the second decorative element comprises one of a second decorative element metallized material, a second decorative textile material, or a second decorative element flock, wherein the third decorative element comprises one of a third decorative element metallized material, a third decorative element textile material, or a third decorative element flock, wherein two or more of the first, second and third decorative element textile materials differ in one or both of composition and texture, wherein the second and third decorative element flocks are the same or differ.

20. The method of claim 4, wherein the second and third decorative elements have opposing first and second surfaces, wherein the first decorative element is positioned adjacent the second decorative element first surface and the third decorative element first surface, the method further comprising:
contacting a fourth adhesive with one or both of the second decorative element second surface and the third decorative element second surface.

21. The method of claim 20, wherein the contacting of the fourth adhesive with the one or both of the second decorative element second surface and third decorative element second surface, further comprises one or more of:
screen-printing the fourth adhesive on the one or both of the second decorative element second surface and the third decorative element second surface;
contacting the fourth adhesive in the form of a self-supporting second adhesive film with the one or both of the second decorative element second surface and the third decorative element second surface;
spraying the fourth adhesive on the one or both of the second decorative element second surface and the third decorative element second surface;
depositing the fourth adhesive, in particulate form, on the one or both of the second decorative element second surface and third decorative element second surface; or
a combination thereof.

22. The method of claim 20, wherein the fourth adhesive comprises one or more of:
a thermosetting adhesive;
a thermoplastic adhesive;
a substantially A-staged thermosetting adhesive;
a substantially B-staged thermosetting adhesive;
a self-supporting adhesive film;
a bi-laminate adhesive film having first and second adhesive layers, the first adhesive layer and second adhesive layer differ in one or both of chemical composition and physical properties;
a tri-laminate adhesive film having a polymeric film positioned between a first adhesive film and a second adhesive film, wherein the first adhesive film and second adhesive film may:
i) differ in one or both of chemical composition and physical properties, or
ii) have substantially the same chemical composition and physical properties, and
wherein the polymeric film may comprise one or more of:
iii) an elastomeric material;
iv) a substantially inelastic material;
v) clear, opaque, colored, uncolored;
vi) a combination thereof; or
a fast flow, low-melt adhesive; and
a hot-melt adhesive.

23. The method of claim 22, further comprising:
contacting a spacer with some, but not all, of the fourth adhesive.

24. The method of claim 23, further comprising:
contacting the fourth adhesive with a substrate; and
adhering the first, second and third decorative elements to the substrate.

25. The method of claim 20, further comprising:
contacting the fourth adhesive with a substrate; and
adhering the first, second and third decorative elements to the substrate.

26-42. (canceled)
